(19) United States
(12) Patent Application Publication
(10) Pub. No.: US 2012/0008044 A1
(43) Pub. Date: Jan. 12, 2012

(54) TRANSMITTING APPARATUS, RECEIVING APPARATUS, SYSTEM, AND METHOD USED THEREIN

(76) Inventors: Shigetaka Nagata, Hyogo (JP); Atsushi Tabuchi, Hyogo (JP); Rio Onishi, Hyogo (JP)

(21) Appl. No.: 13/142,417

(22) PCT Filed: Dec. 25, 2008
(86) PCT No.: PCT/JP2008/003961

§ 371 Date: Sep. 23, 2011

(51) Int. Cl. H04N 7/00; H04N 5/445

(52) U.S. Cl. 348/478; 348/473; 348/E05.097

(57) ABSTRACT

A transmitting apparatus for transmitting transmission data to a receiving apparatus is disclosed which includes: means for obtaining apparatus information of the receiving apparatus; a source of video data and its auxiliary data; means for determining whether or not to synthesize the video data and the auxiliary data with each other, based on the obtained apparatus information; means for synthesizing, according to the above determination, the video data and frame data which is the auxiliary data associated with a frame of the video data, to generate the transmission data, wherein the frame data is included in a video data arranging area of the video data; and means for transmitting the transmission data to the receiving apparatus. Furthermore, a receiving apparatus is also disclosed which extracts the frame data from the video data arranging area of received data.

### TECHNICAL FIELD

The present invention relates to a transmitting apparatus, a receiving apparatus, a relevant system, and a method used therein, and in particular, relates to those used for transmitting a video image and its auxiliary data.

### BACKGROUND ART

As a display apparatus for converting the frame rate of a video image and displaying the video image, a frame rate conversion system is known, which transmits digital video signals based on an HDMI (High Definition Multimedia Interface) standard when a playback apparatus transmits video data. More specifically, the playback apparatus inserts reference control data, which includes a motion vector obtained by decoding encoded video data, into a blanking interval (i.e., a data island period) of a video signal, so as to transmit the reference control data, and the display apparatus generates a frame, which is inserted between frames of video data, which is received from the playback apparatus, by using the motion vector (see, for example, Patent Document 1).

Here, “frame” indicates each static image for forming a video image, and “frame rate” is a value which indicates the number of static frames, which form a video image, per unit time.

### Patent Citation 1: Japanese Unexamined Patent Application, First Publication No. 2007-274679.

### DISCLOSURE OF INVENTION

### Technical Problem

LSI (Large Scale Integration) products for transmitting and receiving a digital video signal between apparatuses (e.g., an HDMI transmitter and HDMI receiver for transmitting and receiving a digital video signal based on the HDMI standard) have a problem such that few products can insert auxiliary data into the data island period.

In addition, an HDMI transmitter, which can set auxiliary data, receives a video signal and auxiliary data to be inserted asynchronously, that is, separately, and inserts the signal of the auxiliary data into the data island period of a frame of the video signal. Therefore, the auxiliary data cannot be embedded synchronously with the video signal. Accordingly, when transmitting data, which is associated as auxiliary data with a frame of a video signal, an external unit outside the HDMI transmitter, to which the relevant auxiliary data is input, cannot know which frame of the video signal has the data island period into which the auxiliary data is inserted.

On the other hand, an HDMI receiver, which can set auxiliary data, outputs a video signal and auxiliary data, which has been inserted, asynchronously, that is, separately, and thus cannot output them synchronously. When outputting auxiliary data, the relationship between the auxiliary data and the frame which has the data island period into which the auxiliary data has been inserted is unclear. Therefore, there is a problem such that an external unit outside the HDMI receiver cannot know into which frame of the video signal the auxiliary data has been inserted. Accordingly, there is a problem such that when receiving data, which is associated as auxiliary data to a frame of a video signal, it is difficult for an external unit outside the HDMI receiver to determine to which frame of the video signal the auxiliary data, which is obtained from the HDMI receiver, has corresponded.

Therefore, the present invention has an object to provide a transmitting apparatus, a receiving apparatus, a relevant system, and a method used therein, which are novel and effective for solving the above-described problems. A more specific object of the present invention is to provide a transmitting apparatus, a receiving apparatus, a relevant system, and a method used therein, in which when transmitting and receiving a digital video signal between apparatuses, video data and frame data are transmitted so that the receiver side can determine with which frame of the video data the auxiliary data (which has been associated with a frame) is associated.

### Technical Solution

According to an aspect of the present invention, there is provided a transmitting apparatus for transmitting transmission data to a receiving apparatus, where the transmitting apparatus includes: means for obtaining apparatus information of the receiving apparatus; a source of video data and its auxiliary data; means for determining whether or not the video data and the auxiliary data are synthesized with each other, based on the obtained apparatus information; means for synthesizing, according to the above determination, the video data and frame data which is the auxiliary data associated with a frame of the video data, to generate the transmission data, wherein the frame data is included in a video data arranging area of the video data; and means for transmitting the transmission data to the receiving apparatus.

According to the present invention, the frame data, which is the auxiliary data associated with a frame of the video data, is synthesized with the video data in a manner such that the frame data is included in the video data arranging area of the video data. Therefore, the video data and the frame data can be transmitted so that the receiving side can determine with which frame of the video data the frame data is associated.

According to another aspect of the present invention, there is provided a transmitting apparatus for transmitting transmission data to a receiving apparatus, where the transmitting apparatus includes: a source of video data and its auxiliary data; a data synthesizer for synthesizing the video data and frame data which is the auxiliary data associated with a frame of the video data, to generate the transmission data, wherein the frame data is included in a video data arranging area of the video data; a CPU; a transmitter, wherein the CPU is configured to obtain apparatus information of the receiving apparatus; determine whether or not the video data and the auxiliary data are synthesized with each other, based on the obtained apparatus information; and make the transmitter transmit the transmission data generated by the data synthesizer to the receiving apparatus when it is determined that the video data and the auxiliary data are synthesized.

According to the present invention, the same advantageous effects as the invention according to the above-mentioned transmitting apparatus are obtained.

According to another aspect of the present invention, there is provided a receiving apparatus including: means for receiving data which includes video data and frame data which is arranged in a video data arranging area of each frame of the video data, and is associated with the frame; means for extracting the frame data from the video data arranging area; means for synthesizing the video data with the frame data for each frame; and means for outputting the synthesized video data and frame data.

According to the present invention, data, which includes video data and frame data, which is arranged in a video data arranging area of each frame of the video data and is associated with the frame, is received, and the frame data is extracted from the video data arranging area. Therefore, the receiving side can determine with which frame of the video data the frame data is associated.

According to another aspect of the present invention, there is provided a receiving apparatus including: a receiver for receiving data which includes video data and frame data which is arranged in a video data arranging area of each frame of the video data, and is associated with the frame; a CPU; and an output unit for outputting the synthesized video data and frame data, wherein the CPU is configured to extract the frame data from the video data arranging area; and synthesize the video data and the frame data for each frame.

According to the present invention, the same advantageous effects as the invention according to the above-mentioned receiving apparatus are obtained.

According to another aspect of the present invention, there is provided a system having a transmitting apparatus and a receiving apparatus which is connected to the transmitting apparatus, wherein:

the transmitting apparatus includes means for obtaining apparatus information of the receiving apparatus; a source of video data and its auxiliary data; means for determining whether or not the video data and the auxiliary data are synthesized with each other, based on the obtained apparatus information; means for synthesizing, according to the above determination, the video data and frame data which is the auxiliary data associated with a frame of the video data, to generate transmission data, wherein the frame data is included in a video data arranging area of the video data; and means for transmitting the transmission data to the receiving apparatus; and the receiving apparatus includes means for receiving the transmission data; means for extracting the frame data from the video data arranging area; means for synthesizing the video data with the frame data for each frame; and means for outputting the synthesized video data and frame data.

According to the present invention, the frame data, which is associated with each frame of the video data, is synthesized with the video data in a manner such that the frame data is included in the video data arranging area of the video data. The synthesized data is transmitted, and then received. The frame data is extracted from the video data arranging area. Therefore, the video data and the frame data can be transmitted so that the receiving side can determine with which frame of the video data the frame data is associated.

According to another aspect of the present invention, there is provided a method of transmitting transmission data to a receiving apparatus, including: a step of obtaining apparatus information of the receiving apparatus; a step of determining whether or not supplied video data and auxiliary data are synthesized with each other, based on the obtained apparatus information; a step of synthesizing, according to the above determination, the video data and frame data which is the auxiliary data associated with a frame of the video data, to generate the transmission data, wherein the frame data is included in a video data arranging area of the video data; and a step of transmitting the transmission data to the receiving apparatus.

According to the present invention, the frame data, which is the auxiliary data associated with a frame of the video data, is synthesized with the video data in a manner such that the frame data is included in the video data arranging area of the video data. Therefore, the video data and the frame data can be transmitted so that the receiving side can determine with which frame of the video data the frame data is associated.

According to another aspect of the present invention, there is provided a method including: a step of receiving data which includes video data and frame data which is arranged in a video data arranging area of each frame of the video data, and is associated with the frame; a step of extracting the frame data from the video data arranging area; a step of synthesizing the video data with the frame data for each frame; and a step of outputting the synthesized video data and frame data.

According to the present invention, data, which includes video data and frame data which is arranged in a video data arranging area of each frame of the video data and is associated with the frame, is received, and the frame data is extracted from the video data arranging area. Therefore, the receiving side can determine with which frame of the video data the frame data is associated.

In the present description and claims, an “active pixel period” is a video data period or a period which is determined as a video data period, within each horizontal scanning line period.

### Advantageous Effects

According to the present invention, it is possible to provide a transmitting apparatus, a receiving apparatus, a relevant system, and a method used therein, by which video data and frame data can be transmitted in a manner such that the receiving side can determine with which frame of the video data the frame data is associated.

### BRIEF DESCRIPTION OF THE DRAWINGS

FIG. 1 is a general block diagram showing the structure of a video transmitting and receiving system as a first embodiment of the present invention.

FIG. 2 is a diagram which explains the channel structure of the HDMI standard, so as to connect the HDMI transmitter and the HDMI receiver.

FIG. 3 is a diagram showing an example of the structure of a signal transmitted through the TMDS channels.

FIG. 4 is a general block diagram showing the structure of the TC adder in the first embodiment.

FIG. 5 is a general block diagram showing the structure of the TC extractor in the first embodiment.

FIG. 6 is a timing chart showing an example of the signals output from each relevant part in the video transmitting apparatus of the first embodiment.

FIG. 7 is a timing chart showing an example of the signals output from each relevant part in the video receiving apparatus of the first embodiment.

FIG. 8 is a general block diagram showing the structure of a video transmitting and receiving system as a second embodiment of the present invention.

FIG. 9 is a general block diagram showing the structure of the TC adder of the second embodiment.

FIG. 10 is a general block diagram showing the structure of the TC extractor of the video receiving apparatus in the second embodiment.

FIG. 11 is a general block diagram showing the structure of a video transmitting and receiving system as a third embodiment of the present invention.

FIG. 12 is a general block diagram showing the structure of the TC adder in the third embodiment.

FIG. 13 is a general block diagram showing the structure of the TC extractor of the video receiving apparatus in the third embodiment.

FIG. 14 is a general block diagram showing the structure of a video transmitting and receiving system as a fourth embodiment of the present invention.

FIG. 15 is a general block diagram showing the function and structure of the editing apparatus in the fourth embodiment.

FIG. 16 is a diagram showing the structure of video data, which has the time code and is output from the TC-added video data writer in the fourth embodiment.

FIG. 17 is a general block diagram showing the structure of the video interface in the fourth embodiment.

FIG. 18 is a general block diagram showing the structure of a video transmitting and receiving system as a fifth embodiment of the present invention.

FIG. 19 is a general block diagram showing the function and structure of the editing apparatus in the fifth embodiment.

FIG. 20 is a general block diagram showing the structure of the video interface in the fifth embodiment.

### BEST MODE FOR CARRYING OUT THE INVENTION

Hereinafter, embodiments according to the present invention will be described with reference to the drawings.

### First Embodiment

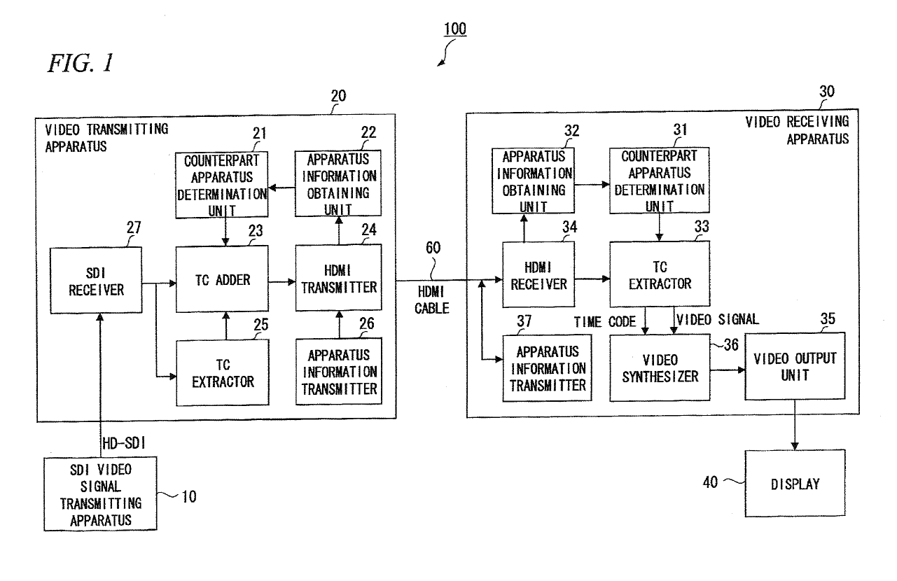

FIG. 1 is a general block diagram showing the structure of a video transmitting and receiving system as a first embodiment of the present invention. Referring to FIG. 1, the video transmitting and receiving system 100 includes an SDI video signal transmitting apparatus 10, a video transmitting apparatus 20, a video receiving apparatus 30, a display 40, and an HDMI cable 60. The video transmitting apparatus 20 and the video receiving apparatus 30 are connected to each other via the HDMI cable 60 used for transmitting a video signal based on the HDMI standard from the video transmitting apparatus 20 to the video receiving apparatus 30. The video transmitting apparatus 20 includes a counterpart apparatus determination unit 21, an apparatus information obtaining unit 22, a TC adder 23, an HDMI transmitter 24, a TC extractor 25, an apparatus information transmitter 26, and an SDI receiver 27. The video receiving apparatus 30 includes a counterpart apparatus determination unit 31, an apparatus information obtaining unit 32, a TC extractor 33, an HDMI receiver 34, a video output unit 35, a video synthesizer 36, and an apparatus information transmitter 37.

The SDI video signal transmitting apparatus 10 performs transmission of a video signal based on an HD-SDI (High Definition Serial Digital Interface) standard. A time code is added to each frame of a video signal transmitted by the SDI video signal transmitting apparatus 10. The video transmitting apparatus 20 receives each video signal which is based on the HD-SDI standard and transmitted from the SDI video signal transmitting apparatus 10, converts transmission data which is included in the received video signal and contains video data and time codes appended to the video data into a video signal based on the HDMI standard, and transmits the converted video signal to the video receiving apparatus 30. In the following explanations, each video signal includes, not only video data, but also audio data.

The SDI receiver 27 receives a video signal based on the HD-SDI standard, which is a source of video data and auxiliary data thereof in the first embodiment, and is transmitted from the SDI video signal transmitting apparatus 10. The video signal based on the HD-SDI standard includes, not only video data, but also a time code (indicating the hour, minute, second, and the frame number) of each frame in the blanking interval of the relevant frame of the video signal, where the time code is frame data which is associated with each frame of the video data, and belongs to auxiliary data of video data in the first embodiment. The TC extractor 25 extracts the time code of each frame, which is inserted according to the HD-SDI standard into the blanking interval of a video signal based on the HD-SDI standard, which is received from the SDI receiver 27.

The apparatus information obtaining unit 22 obtains apparatus information of an apparatus to which transmission data (including video data and time codes) is transmitted, that is, apparatus information of the video receiving apparatus 30, from the video receiving apparatus 30. The apparatus information includes data by which it can be determined whether or not the video receiving apparatus 30 can receive a video signal having synthesized video data and time code. Such data may be included in “EDID (Extended Display Identification Data)” output from the apparatus information transmitter 37 (explained later) of the video receiving apparatus 30. EDID may include the EISA identification code of the manufacturer, the product code, the serial number, the year and week of manufacture, the version number, the revision number, and resolution data (which is supported) of the video receiving apparatus 30. In addition, the “Manufacturer block” of EDID may include data which directly indicates whether or not a video signal having synthesized video data and time code can be received.

Based on the obtained apparatus information, the counterpart apparatus determination unit 21 determines whether the video data and the time code are synthesized to each other. That is, the counterpart apparatus determination unit 21 determines, based on the obtained apparatus information, whether or not the video receiving apparatus 30 can receive a video signal having synthesized video data and time code. If the video receiving apparatus 30 can receive it according to the determination, it is determined that the video data and the time code are synthesized, and if not, it is determined that such synthesis is not performed. Here, the determination whether or not the video receiving apparatus 30 can receive a video signal having synthesized video data and time code may be performed by the counterpart apparatus determination unit 21, which stores apparatus information of each apparatus which can perform such reception, and checks whether or not the stored apparatus information has data which coincides with the obtained apparatus information. The above apparatus information may include at least one of the EISA identification code of the manufacturer, the product code, the serial number, the year and week of manufacture, the version number, the revision number, the supported resolution data, and the like. In addition, when the apparatus information includes data which directly indicates whether or not a video signal having synthesized video data and time code can be received, the determination of whether or not such a synthesized video signal can be received may be performed based on the apparatus information.

When the counterpart apparatus determination unit 21 determines that the synthesis is to be performed, the TC adder 23 includes frame data (i.e., the time code received from the TC extractor 25), which is auxiliary data associated with the relevant frame of the video data, in a video data arranging area for arranging the video data, and synthesizes the time code with video data corresponding to a video signal of the HD-SDI standard, which is received from the SDI receiver 27, thereby generating transmission data. In the first embodiment, when the TC adder 23 generates the transmission data, it provides an area including the frame data in the video data arranging area. Also in the first embodiment, the area including the frame data is an active pixel period which is additionally provided in a horizontal scanning line period of a vertical blanking interval. The synthesis by the TC adder 23 of the frame data with the video data will be explained in detail later. On the other hand, when the counterpart apparatus determination unit 21 determines that the synthesis is not to be performed, the TC adder 23 directly outputs the video data corresponding to the video signal based on the HD-SDI standard, which is received from the SDI receiver 27.

The HDMI transmitter 24 is an HDMI transmitter for converting the data generated by the TC adder 23 into a video signal based on the HDMI standard, and transmitting the converted signal to the video receiving apparatus 30, wherein auxiliary data to be inserted into a data island period cannot be set by an external device. The HDMI transmitter 24 may be formed of a discrete circuit or an LSI, and generally, it is formed of an LSI or of an integrated circuit which is a part of an LSI. When a DE signal output from the TC adder 23 is a “Low” signal, the HDMI transmitter 24 determines that the present period is a vertical blanking interval or a horizontal blanking interval. When the DE signal is a “High” signal, the HDMI transmitter 24 determines that the present period corresponds to the video data arranging area where the video data is arranged. When the HDMI transmitter 24 determines that the present period is the video data arranging area, the HDMI transmitter 24 converts the data in this area into a video signal stored in an active area, which is a video data arranging area for a video signal based on the HDMI standard. The HDMI transmitter 24 transmits the converted video signal to the video receiving apparatus 30.

Additionally, according to a request from the apparatus information obtaining unit 22, the HDMI transmitter 24 accesses the apparatus information transmitter 37 through a DCC (Display Data Channel), so as to request the apparatus information transmitter 37 to transmit apparatus information stored therein. The HDMI transmitter 24 then obtains the apparatus information output from the apparatus information transmitter 37. The apparatus information transmitter 26 outputs apparatus information for identifying the type of the video transmitting apparatus 20. Here, the HDMI transmitter 24 inserts this apparatus information into a data island period of a video signal of the HDMI standard, and transmits it to the video receiving apparatus 30. The data island period in a video signal of the HDMI standard will be explained later.

The apparatus information transmitter 37 is a ROM (Read Only Memory) or RAM (Random Access Memory), which stores apparatus information of the video receiving apparatus 30, and outputs the stored apparatus information according to a request received from the video transmitting apparatus 20 via the HDMI cable 60. The HDMI receiver 34 is an HDMI receiver, which is connected to the HDMI transmitter 24 of the video transmitting apparatus 20 via the HDMI cable, and receives a video signal based on the HDMI standard, which is transmitted from the HDMI transmitter 24 via the HDMI cable. The HDMI receiver 34 may be formed of a discrete circuit or an LSI, and generally, it is formed of an LSI or of an integrated circuit which is a part of an LSI. The video signal of the HDMI standard transmitted by the HDMI transmitter 24 includes video data and a time code which is included in the video data arranging area for each frame of the video data. The apparatus information of the video transmitting apparatus 20 is also included in the data island period of the above video signal.

The apparatus information obtaining unit 32 obtains the apparatus information of the video transmitting apparatus 20 from the video signal received by the HDMI receiver 34, and outputs it to the counterpart apparatus determination unit 31. Based on the apparatus information of the video transmitting apparatus 20, the counterpart apparatus determination unit 31 determines whether or not the time code is extracted from the video signal received by the HDMI receiver 34. That is, the counterpart apparatus determination unit 31 determines, based on the obtained apparatus information, whether or not the apparatus which transmits data can transmit a video signal including video data and a time code which have been synchronized. If such transmission is possible, the counterpart apparatus determination unit 31 determines that the time code is to be extracted, and if not, it is determined that the time code is not to be extracted. The determination whether the apparatus which transmits data can transmit a video signal including video data and a time code which have been synchronized may be performed by the counterpart apparatus determination unit 31, which stores apparatus information of each apparatus which can perform such transmission, and checks whether or not the stored apparatus information has data which coincides with the obtained apparatus information. In addition, the apparatus information may include data which indicates whether such a synthesized video signal can be transmitted, and the determination may be performed based on such apparatus information.

The TC extractor 33 extracts the time code from the video data arranging area of the video signal which is received by the HDMI receiver 34. In the first embodiment, the TC extractor 33 extracts a time code included in an active pixel period in the video data arranging area, and generates video data from which the active pixel period (from which the time code has been extracted) is removed. In this process, the frame with which the time code is associated includes the video data arranging area from which the time code has been extracted. Therefore, the TC extractor 33 can determine correspondence between the time code and the frame, and output the video data, which forms the frame, and the time code, which is associated with the frame, synchronously.

The video synthesizer 36 synthesizes the video image of the video data, which is generated and extracted by the TC extractor 33, with the time code for each frame. Such synthesis produces an image in which the time code is displayed in each frame (for example, at the left end of the frame). The video output unit 35 (e.g., video output terminal) outputs the video signal of the synthesized video image. The display 40 is a display apparatus which has a CRT (Cathode Ray Tube), a liquid crystal display, a plasma display, or the like, and displays video image of the video signal output from the video output unit 35.

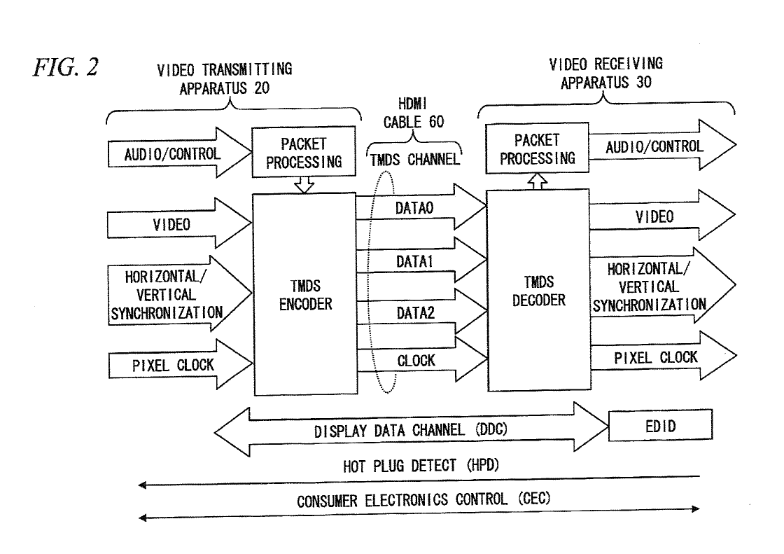

FIG. 2 is a diagram which explains the channel structure of the HDMI standard, so as to connect the video transmitting apparatus 20 and the video receiving apparatus 30. Referring to FIG. 2, the channels based on the HDMI standard include TMDS (Transition Minimized Differential Signaling) channels, a display data channel (DDC), a hot plug detect (HPD) channel, and a consumer electronics control (CEC) channel.

The TMDS channels are one-way channels from the video transmitting apparatus 20 to the video receiving apparatus 30. Through these channels, audio/control data, which has been processed to have a packet form, video data, horizontal/vertical synchronization signals, and a clock signal are converted by a TMDS encoder into signals corresponding to the TMDS standard, and transmitted. The display data channel is a channel through which the video transmitting apparatus 20 transmits a request for apparatus information, and the video receiving apparatus 30 transmits the apparatus information (EDID) according to the request. The hot plug detect channel is a channel for informing the video transmitting apparatus 20 that the apparatus information (EDID) of the video receiving apparatus 30 can be obtained through the display data channel, or that the apparatus information (EDID) has been changed. The consumer electronics control channel is a channel for transmitting control signals between the relevant devices bidirectionally.

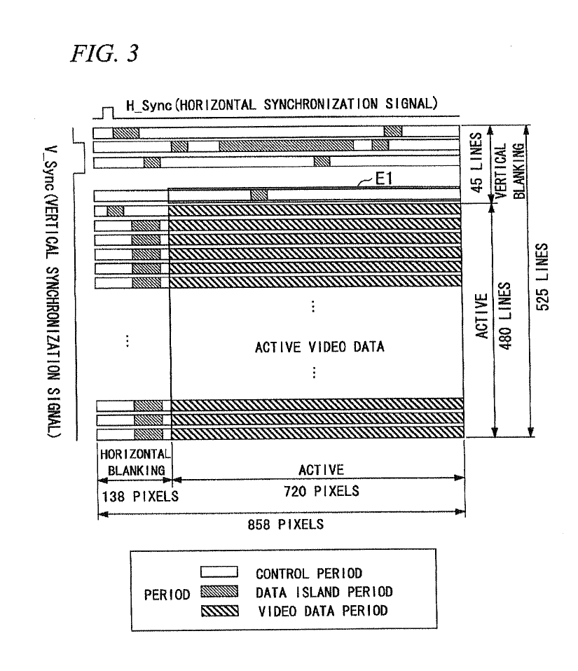

FIG. 3 is a diagram showing an example of the structure of a signal transmitted through the TMDS channels. Referring to FIG. 3, the example of the structure employs a signal for transmitting video data for progressive scanning, where the size of each frame is 720 pixels horizontally and 480 lines vertically. Each signal transmitted through the TMDS channels is a video signal in raster scan form. If the scanning type of video data is not progressive scanning, but interlaced scanning, then the top field and the bottom field are indicated using timings of the horizontal synchronization signal (H_Sync) and the vertical synchronization signal (V_sync) included in the video signal. That is, when the rising of the vertical synchronization signal is in synchronism with that of the horizontal synchronization signal, it indicates the top field. When the rising of the vertical synchronization signal is positioned at the midpoint of the horizontal synchronization signal, it indicates the bottom field. As shown in FIG. 3, the video signal consists of control periods and data island periods, which are inserted in the vertical blanking interval (45 lines in FIG. 3) and the horizontal blanking interval (138 pixels in FIG. 3), and video data periods (which may be called an “active area”) as the video data arranging area. In addition, the video data period in each horizontal scanning line period is the active pixel period. Additionally, the present example employs video data for progressive scanning.

The TC adder 23 defines a part (e.g., a period indicated by a reference symbol E1 in FIG. 3) of a horizontal scanning line period, which belongs to a vertical blanking interval of each frame in video data, and is positioned before the video data period, as an active pixel period, and stores a time code of the relevant frame in the period E1. The period E1 starts immediately after 138 pixels which start from the head of the relevant horizontal scanning line period and function as a horizontal blanking interval, and has a length of 720 pixels which correspond to the horizontal width of the relevant video image.

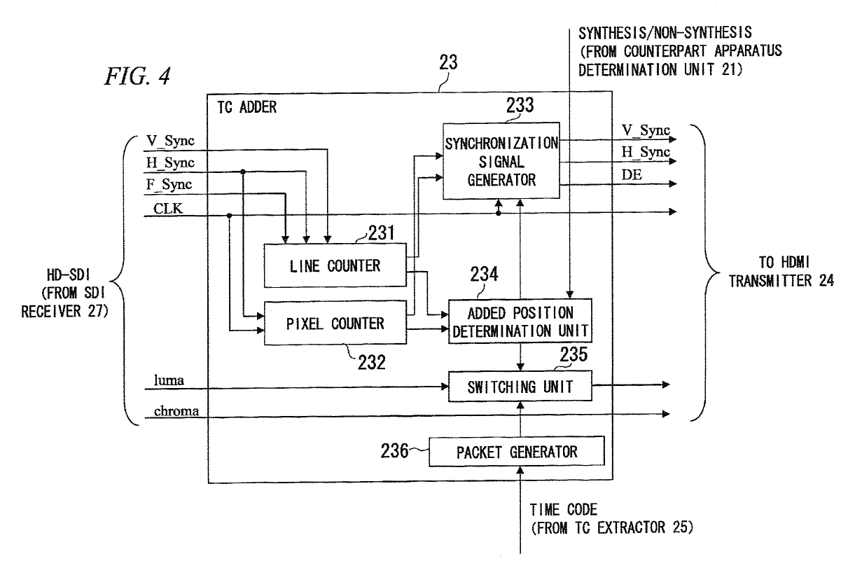

FIG. 4 is a general block diagram showing the structure of the TC adder in the first embodiment. Referring to FIG. 4, the TC adder 23 has a line counter 231, a pixel counter 232, a synchronization signal generator 233, an added position determination unit 234, a switching unit 235, and a packet generator 236.

The line counter 231 is reset by a vertical synchronization signal (V_sync) from the SDI receiver 27, and counts the number of lines (i.e., the number of horizontal scanning lines) by performing a count-up operation using a horizontal synchronization signal (H_sync) from the SDI receiver 27. The pixel counter 232 is reset by the horizontal synchronization signal (H_sync) from the SDI receiver 27, and counts the number of pixels by performing a count-up operation using a clock signal (CLK) from the SDI receiver 27.

The synchronization signal generator 233 monitors the number of lines counted by the line counter 231 and the number of pixels counted by the pixel counter 232 according to the timing of the clock signal (CLK) from the SDI receiver 27, and performs switching of the High/Low state of each synchronization signal (i.e., horizontal synchronization signal (H_Sync), vertical synchronization signal (V_sync), and DE (Data Enable) signal (DE)) according to the resolution and the interlace/progressive form of the video image, so as to generate synchronization signals for the HDMI standard. The DE signal is a signal which indicates whether or not the relevant area is a video data arranging area (active area), that is, whether or not “luma” and “chroma” having the same timing are video data. In addition, while the synchronization signal generator 233 is informed by the added position determination unit 234 that the present period is a period for storing a time code (e.g., from the 139th pixel to the 858th pixel on the 45th line for the period indicated by the reference symbol E1 in FIG. 3), the synchronization signal generator 233 switches the output state of the DE signal to “High” so that the HDMI transmitter 24 and the HDMI receiver 34 can recognize that the relevant period is the active pixel period. Accordingly, the synchronization signal generator 233 provides an active pixel period in a horizontal scanning line period of a vertical blanking interval, thereby enlarging the video data arranging area. When an active pixel period is added as described above, the number of lines of the relevant vertical blanking interval is decreased by one in comparison with a case where no time code is added, and is thus 44 lines in FIG. 3. In contrast, the number of lines of the relevant video data arranging area increases by one, and is thus 481 lines in FIG. 3.

When the added position determination unit 234 receives a synthesis/non-synthesis designation from the counterpart apparatus determination unit 21 and the designation indicates “synthesis”, the added position determination unit 234 monitors the number of lines counted by the line counter 231 and the number of pixels counted by the pixel counter 232. When the monitored numbers respectively coincide with predetermined line and pixel numbers for storing the time code, the added position determination unit 234 informs the synchronization signal generator 233 and the switching unit 235 that the period for storing the time code has arrived. Although the line and pixel numbers for storing the time code are determined depending on the size of the frame of the video data, they correspond to an area (blanking interval) on the outside of the video data arranging area for each video signal input into the TC adder 23. In the example of FIG. 3, the line number is “45” and the pixel number is “139” to “858”, which is the period E1. When the designation indicates “non-synthesis”, the added position determination unit 234 issues no designation for switching of the switching unit 235, regardless of the number of lines counted by the line counter 231 and the number of pixels counted by the pixel counter 232.

According to the instruction of the added position determination unit 234, the switching unit 235 performs switching between “luma” (brightness signal) received from the SDI receiver 27 and the packet of the time node received from the packet generator 236. As no switching is performed for “chroma” (color difference signal), the TC adder 23 directly outputs “chroma” received from the SDI receiver 27. The packet generator 236 generates a packet in which a header (e.g., a fixed value of 4 bytes), which indicates that the present packet includes the time code, is inserted in front of the time code received from the TC extractor 25, and a code (e.g., checksum of 2 bytes) for error detection, which is computed using the time code, is added after the time code. The generated packet is output to the switching unit 235. Accordingly, the packet may be data of 10 bytes in which the 4-byte header, the 4-byte time code, and the 2-byte checksum are coupled in this order.

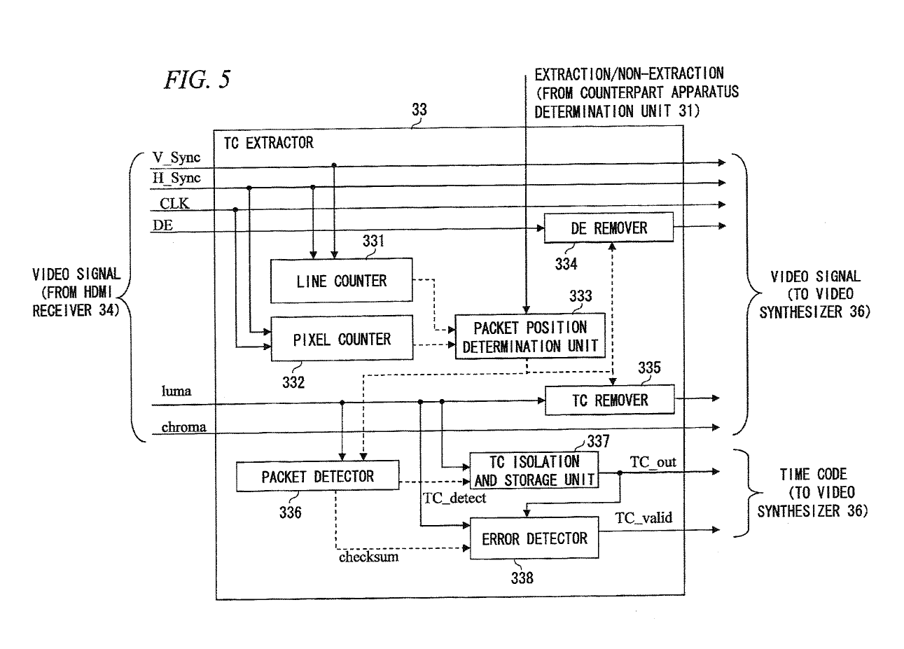

FIG. 5 is a general block diagram showing the structure of the TC extractor in the first embodiment. Referring to FIG. 5, the TC extractor 33 has a line counter 331, a pixel counter 332, a packet position determination unit 333, a DE remover 334, a TC remover 335, a packet detector 336, a TC isolation and storage unit 337, and an error detector 338.

The line counter 331 is reset by a vertical synchronization signal (V_sync) from the HDMI receiver 34, and counts the number of lines (i.e., the number of horizontal scanning lines) by performing a count-up operation using a horizontal synchronization signal (H_sync) from the HDMI receiver 34. The pixel counter 332 is reset by the horizontal synchronization signal (H_sync) from the HDMI receiver 34, and counts the number of pixels by performing a count-up operation using a clock signal (CLK) from the HDMI receiver 34.

When the packet position determination unit 333 receives an extraction/non-extraction designation from the counterpart apparatus determination unit 31, and the designation indicates “extraction”, the packet position determination unit 333 monitors the number of lines counted by the line counter 331 and the number of pixels counted by the pixel counter 332. When the monitored numbers respectively coincide with predetermined line and pixel numbers for storing the time code, the packet position determination unit 333 informs the DE remover 334, the TC remover 335, and the packet detector 336 that the period for storing the time code has arrived.

The DE remover 334 receives the DE (Data Enable) signal, which indicates whether or not the relevant period belongs to the video data arranging area, and “luma” and “chroma”, which have been received synchronously, are video data, and converts the DE signal into a signal having a Low state within the period communicated from the packet position determination unit 333 so as to indicate that “luma” and “chroma”, which have been received synchronously, are not video data. For the period communicated from the packet position determination unit 333, the TC remover 335 replaces “luma” (brightness signal), which is received from the HDMI receiver 34, to a signal having a predetermined value for indicating a blanking interval, so as to remove the packet of the time code stored in the designated period.

From “luma” (brightness signal) received from the HDMI receiver 34, the packet detector 336 extracts a part corresponding to the header of the packet in the period communicated from the packet position determination unit 333, and determines whether or not the extracted part coincides with a header value which indicates that the present packet is a packet for storing the time code. When it is determined that they coincide with each other, the packet detector 336 outputs a signal, which indicates that the relevant packet has been detected, to the TC isolation and storage unit 337 at the timing when the stored time code comes (see “TC_detect”), and also to the error detector 338 at the timing when the stored error detection code comes (see “checksum”). When the TC isolation and storage unit 337 receives the signal, which indicates that the relevant packet has been detected, from the packet detector 336, the TC isolation and storage unit 337 isolates and stores “luma” (brightness signal) as the time code, which is received from the HDMI receiver 34, and outputs the time code (see “TC_out”).

When the error detector 338 receives the signal, which indicates that the relevant packet has been detected, from the packet detector 336, the error detector 338 isolates “luma” (brightness signal), which is received from the HDMI receiver 34, as a code for error detection. The error detector 338 also computes a code for error detection by using the time code which has been isolated and stored by the TC separation and storage unit 337, in a method similar to that performed by the packet generator 236, and compares the computed code with the above isolated code for error detection. The error detector 338 outputs a signal (“TC_valid”) for indicating that the time code is effective when the compared codes coincide with each other, or that the time code is ineffective when both do not coincide with each other.

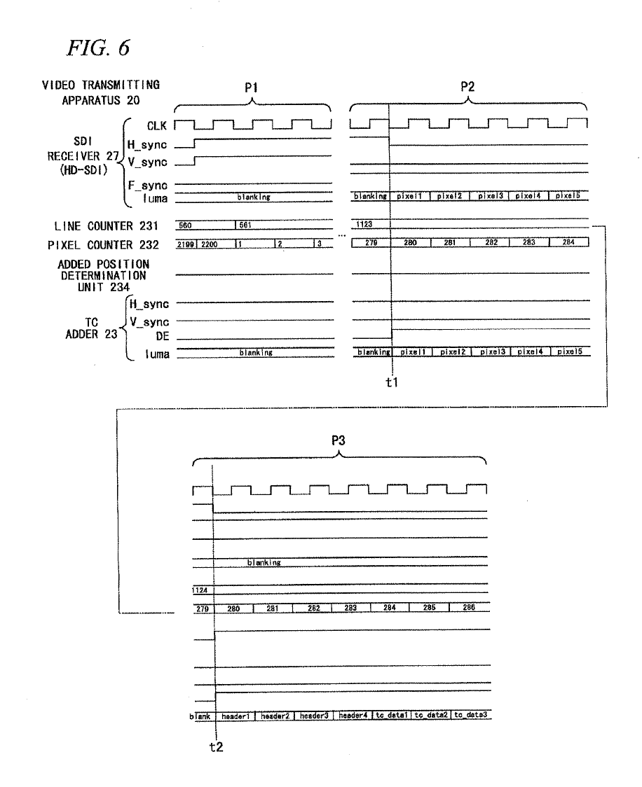

FIG. 6 is a timing chart showing an example of the signals output from the SDI receiver, the line counter, the pixel counter, the added position determination unit, and the TC adder in the video transmitting apparatus of the first embodiment. Referring to FIG. 6, this timing chart employs an example in which the SDI video signal transmitting apparatus 10 outputs a video signal in which the number of pixels is “1920 pixels×1080 lines”, the scanning method is interlace, and the frame rate is 29.97 frame/sec. In FIG. 6, reference symbol P1 indicates the signals output from the SDI receiver 27, the line counter 231, the pixel counter 232, the added position determination unit 234, and the TC adder 23 from the rise of the clock signal at the 2199th pixel on the 560th line of a frame to the rise of the clock signal at the third pixel on the next 561st line. Similarly, reference symbol P2 indicates the signals output from the above-described parts from the fall of the clock signal at the start of the 279th pixel on the 1123rd line to the fall of the clock signal at the end of the 284th pixel on the 1123rd line. Reference symbol P3 indicates the signals output from the above-described parts from the rise of the clock signal at the 279th pixel on the 1124th line to the fall of the clock signal at the end of the 286th pixel on the 1124th line. In the example of FIG. 6, the period for possessing the time code is arranged so that it is added to the end of the frame, and is recognized as the active pixel period. That is, t1 in FIG. 6 shows the arrival time of the pixel number “280” at the head of the active pixel period in the last line (line number “1123”) of the frame. From time t1, “luma” output from the SDI receiver 27 and the TC adder 23 is a signal which indicates the brightness of each pixel of the last line, such as the brightness of “pixel1”, the brightness of “pixel2”, . . .

Next, t2 shows the arrival time of the pixel number “280” at the head of the added active pixel period of the line (line number “1124”). At this time t2, the added position determination unit 234 determines that the number of lines counted by the line counter 231 and the number of pixels counted by the pixel counter 232 correspond to the period which contains the time code, and outputs a “High” signal. When receiving the “High” signal, the switching unit 235 outputs the packet of the time code, which is generated by the packet generator 236, after converting the packet of the time code to the “luma” output from the SDI receiver 27. Therefore, although the signal output from the SDI receiver 27 indicates a blanking interval, the TC adder 23, which receives the packet output from the switching unit 235, outputs the DE signal, whose state is changed to “High” so as to indicate the video data arranging area, and also outputs “luma” which has the value “header 1” of 1 byte at the head of the header which indicates that the present packet is a packet for storing a time code. The “luma” signal then has the values “header2”, “header3”, and “header4” which are each 1 byte data for forming the remaining part of the header, and after that, “luma” has the values “tc_data1”, “tc_data2”, and “tc_data3” which are each 1 byte data for forming the time code (see the area indicated by reference symbol P3).

As the DE signal is switched to the “High” signal for indicating the video data arranging area at this time t2, the HDMI transmitter 24, which receives the DE signal, determines that the relevant period is not the blanking interval but the video data arranging area, and converts the signals such as “luma” and “chroma” into TMDS signals, so as to transmit them to the video receiving apparatus 30 via the HDMI cable 60.

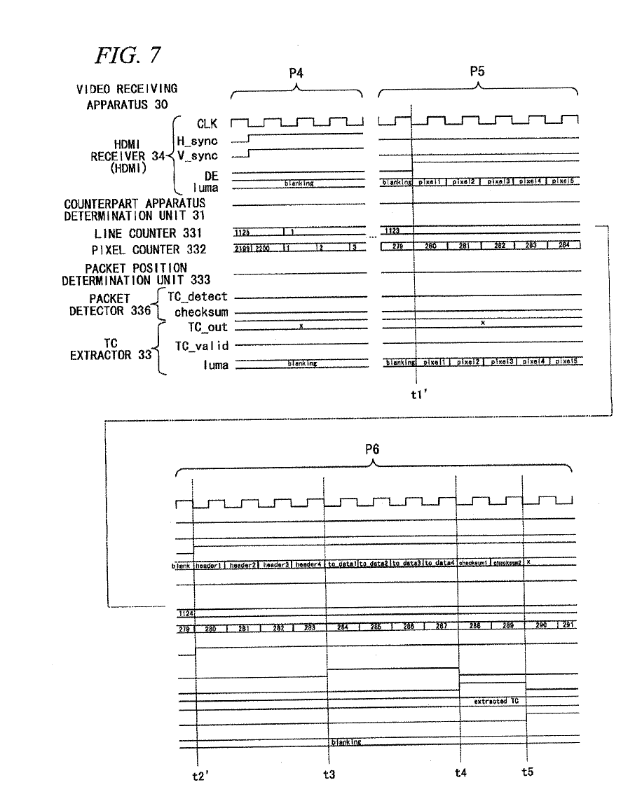

FIG. 7 is a timing chart showing an example of the signals output from the HDMI receiver, the counterpart apparatus determination unit, the line counter, the pixel counter, the packet position determination unit, and the TC extractor in the video receiving apparatus of the first embodiment. Referring to FIG. 7, this timing chart employs an example in which the SDI video signal transmitting apparatus 10 outputs a video signal in which the number of pixels is “1920 pixels×1080 lines”, the scanning method is interlace, and the frame rate is 29.97 frame/sec. In FIG. 7, reference symbol P4 indicates the signals output from the HDMI receiver 34, the counterpart apparatus determination unit 31, the line counter 331, the pixel counter 332, the packet position determination unit 333, the packet detector 336, and the TC extractor 33 from the rise of the clock signal at the 2199th pixel on the 1125th line of a frame to the rise of the clock signal at the third pixel on the first line of the next frame. Similarly, reference symbol P5 indicates the signals output from the above-described parts from the fall of the clock signal at the start of the 279th pixel on the 1123rd line to the fall of the clock signal at the end of the 284th pixel on the 1123rd line. Reference symbol P6 indicates the signals output from the above-described parts from the rise of the clock signal at the 279th pixel on the 1124th line to the rise of the clock signal at the 291st pixel on the 1124th line. In FIG. 7, t1′ and t2′ respectively have the same timings as t1 and t2 in FIG. 6.

From time t2′, the packet position determination unit 333, which has detected the start position of the relevant packet, outputs a “High” signal. When the packet detector 336, which receives this signal, determines that the values “header1”, . . . , “header4” of “luma” of the HDMI receiver 34 coincide with the corresponding values of the header in the packet of the time code, then (i.e., from time t3) the packet detector 336 sets “TC_detect”, which is output to the TC isolation and storage unit 337, to a “High signal” for a time corresponding to 4 clock periods. This period in which “TC_detect” is “High” indicates that in the present period, the time code is included in “luma”. The TC isolation and storage unit 337 isolates the content of the packet within the period in which “TC_detect” is “High”, that is, the time code, from “luma”, and stores the isolated time code. In addition, t4 is the time when 4 clock pulses, which correspond to the data length of the time code, have elapsed from time t3, and from this time t4, the packet detector 336 sets “checksum” to a “High” signal, which indicates the period for the error detection code, and is output to the error detector 338. When the error detector 338 receives this “High” signal, it compares the “luma” value of the HDMI receiver 34 with the value of the error detection code, which is computed using the time code output from the TC isolation and storage unit 337. If compared values coincide with each other, the error detector 338 sets “TC_valid” to a “High” signal, which indicates that the time code output from the TC isolation and storage unit 337 is effective.

As described above, when the added position determination unit 234 of the TC adder 23 determines that the present period is the predetermined period for storing the time code in a blanking interval based on the number of lines counted by the line counter 231 and the number of pixels counted by the pixel counter 232, and sends information of the determination to the switching unit 235, then the switching unit 235, which receives the information, switches “luma” to the packet of the time code (received from the packet generator 236), that is, frame data associated with the relevant frame. In addition, when the synchronization signal generator 233, which also receives the information from the added position determination unit 234, switches the output state of the DE signal, so as to indicate that the relevant period is a video data arranging area, that is, an active pixel period. Accordingly, while the switching unit 235 switches “luma” to the frame data, the synchronization signal generator 233 outputs the DE signal which indicates that the relevant period is an active pixel period. Therefore, the TC adder 23 in the video transmitting apparatus 20 adds an active pixel period, that is, a video data arranging area, so that the frame data can be included in the video data arranging area, so as to synthesize the frame data with the video data.

Accordingly, the video signal transmitted from the video transmitting apparatus 20 includes the frame data of the relevant frame, which corresponds to the video data of the frame, in the video data arranging area of the frame. Therefore, the HDMI receiver 34 of the video receiving apparatus 30, which receives the video signal, processes even the area, which includes the frame data, as video data, and thus outputs the originally-received video signal in which the frame data has been synthesized with the video data. Accordingly, even when the HDMI transmitter 24, which is used for transmitting a digital video signal from the video transmitting apparatus 20 to the video receiving apparatus 30, is a device which cannot set auxiliary data, or can set auxiliary data but sets the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, even when the HDMI receiver 34, which is used for receiving a digital video signal transmitted from the video transmitting apparatus 20 to the video receiving apparatus 30, is a device which cannot output auxiliary data, or can output auxiliary data but outputs the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

Additionally, the area which is provided by the TC adder 23 and contains frame data is an active pixel period which is additionally provided in a horizontal scanning line period within a vertical blanking interval. Therefore, video data and frame data can be transmitted without damaging the video data.

In the first embodiment, the data format for the pixels of video data, which the video transmitting apparatus 20 transmits and the video receiving apparatus 30 receives, is YUV “4:2:2” having “luma” (brightness signal) of 1 byte and “chroma” (color difference signal) of 1 byte for each pixel. However, the data format is not limited to the above, and may be YUV “4:4:4” or RGB.

Also in the first embodiment, the packet of the time code is contained only in the “luma” area. However, it may be contained in the “chroma” area , or may be spread over both “luma” and “chroma”.

In addition, when the data format is changed, or when the packet of the time code is contained in the “chroma” area or in both the “luma” and “chroma” areas, the period in which the time code is included may be arranged to be located before the relevant frame (see FIG. 3) so that the period in which the time code is included is recognized as an active pixel period, or the period in which the time code is included may also be arranged to be located after the relevant frame so that the period in which the time code is included is recognized as an active pixel period.

### Second Embodiment

Below, an embodiment for storing a time code in place of video data in a part of an active pixel period (which includes video data) will be explained as a second embodiment.

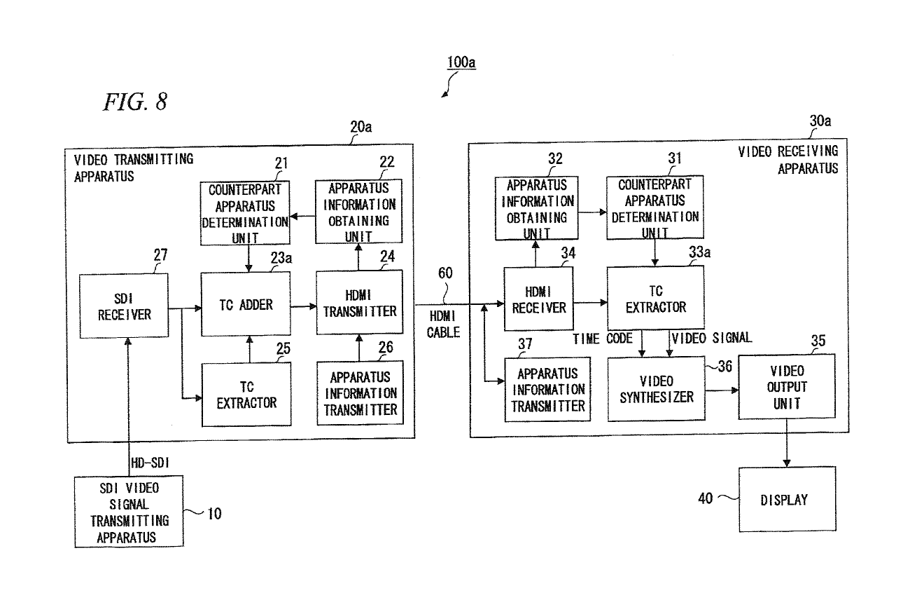

FIG. 8 is a general block diagram showing the structure of a video transmitting and receiving system as the second embodiment of the present invention. Referring to FIG. 8, in comparison with the video transmitting apparatus 20 and the video receiving apparatus 30 of the video transmitting and receiving system 100 of the first embodiment, the video transmitting and receiving system 100a has distinctive corresponding apparatuses, and thus has an SDI video signal transmitting apparatus 10, a video transmitting apparatus 20a, a video receiving apparatus 30a, a display 40, and an HDMI cable 60. The SDI video signal transmitting apparatus 10, the display 40, and the HDMI cable 60 are similar to those in the first embodiment, and explanations thereof are omitted. In comparison with the video transmitting apparatus 20 of the first embodiment, the only distinctive part of the video transmitting apparatus 20a is a TC adder 23a substituted for the TC adder 23. Therefore, explanations of the other parts (21, 22, and 24 to 27) are omitted. In comparison with the video receiving apparatus 30 of the first embodiment, the only distinctive part of the video receiving apparatus 30a is a TC extractor 33a substituted for the TC extractor 33. Therefore, explanations of the other parts (31, 32, and 34 to 37) are omitted.

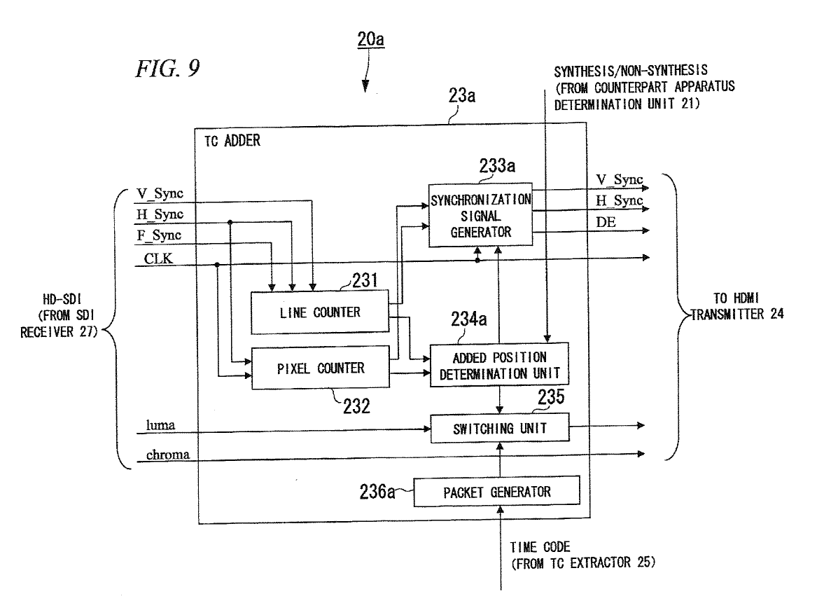

FIG. 9 is a general block diagram showing the structure of the TC adder of the second embodiment. In FIG. 9, parts identical to those in FIG. 4 are given identical reference numerals (231, 232, and 235), and explanations thereof are omitted. Referring to FIG. 9, the TC adder 23a has a line counter 231, a pixel counter 232, a synchronization signal generator 233a, an added position determination unit 234a, a switching unit 235, and a packet generator 236a.

The synchronization signal generator 233a monitors the number of lines counted by the line counter 231 and the number of pixels counted by the pixel counter 232 according to the timing of the clock signal (CLK) from the SDI receiver 27, and performs switching of the High/Low state of each synchronization signal (i.e., horizontal synchronization signal (H_Sync), vertical synchronization signal (V_sync), and DE signal (DE)) according to the resolution and the interlace/progressive form of the video image, so as to generate synchronization signals for the HDMI standard.

Similar to the added position determination unit 234 in FIG. 4, when the added position determination unit 234a receives a synthesis/non-synthesis designation from the counterpart apparatus determination unit 21 and the designation indicates “synthesis”, the added position determination unit 234a monitors the number of lines counted by the line counter 231 and the number of pixels counted by the pixel counter 232. When the monitored numbers respectively coincide with predetermined line and pixel numbers for storing the time code, the added position determination unit 234a informs the switching unit 235 that the period for storing the time code has arrived. In comparison with the added position determination unit 234, the period for storing the time code is an active pixel period in the received HD-SDI video signal.

Similar to the packet generator 236 in FIG. 4, the packet generator 236a generates a packet in which a header (e.g., a fixed value of 4 bytes), which indicates that the present packet includes the time code, is inserted in front of the time code received from the TC extractor 25, and a code (e.g., checksum of 2 bytes) for error detection, which is computed using the time code, is added after the time code. The packet generator 236a divides the generated packet into 4-bit pieces, and generates a data sequence in which a fixed value (e.g., a binary value of “0101”) is added to the upper-side of each 4-bit piece. The generated data sequences is output to the switching unit 235. Therefore, the packet generator 236a embeds the data of the generated packet into only the lower 4 bits, where the upper 4 bits have an appropriate value, thereby preventing “luma” from having a reserved value which indicates a specific meaning.

Accordingly, the TC adder 23a replaces video data, which is arranged in at least one predetermined active pixel period in a horizontal scanning line period, with data which indicates a time code. Additionally, in the second embodiment, said at least one predetermined active pixel period (e.g., the uppermost active pixel period or the lowermost active pixel period) is adjacent to an area on the outside of the video data arranging area. That is, in the first embodiment, the time code is contained in an active pixel period which is provided in one of horizontal scanning line periods within the vertical blanking interval, in which no effective video data is stored. In contrast, in the second embodiment, an active pixel period in which video data is stored is replaced with the time code.

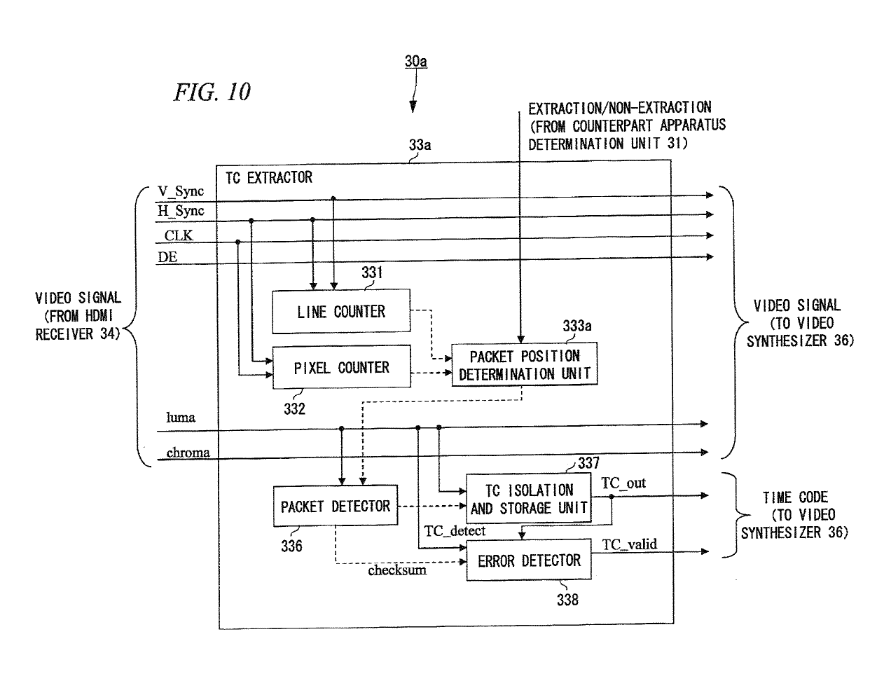

FIG. 10 is a general block diagram showing the structure of the TC extractor of the video receiving apparatus in the second embodiment. In FIG. 10, parts identical to those in FIG. 5 are given identical reference numerals (331, 332, and 336 to 338), and explanations thereof are omitted. Referring to FIG. 10, in comparison with the TC extractor 33 in FIG. 5, which has the packet position determination unit 333, a TC extractor 33a has a packet position determination unit 333a, and has no DE remover 334 and TC remover 335.

Similar to the packet position determination unit 333, when the packet position determination unit 333a receives an extraction/non-extraction designation from the counterpart apparatus determination unit 31 and the designation indicates “extraction”, the packet position determination unit 333a monitors the number of lines counted by the line counter 331 and the number of pixels counted by the pixel counter 332. When the monitored numbers respectively coincide with predetermined line and pixel numbers for storing the time code, the packet position determination unit 333a informs the packet detector 336 that the period for storing the time code has arrived. However, in contrast with the packet position determination unit 333, the period for storing the time code is at least one predetermined active pixel period in which video data has been originally stored. Accordingly, the TC extractor 33a extracts a time code contained in at least one predetermined active pixel period of video data. Additionally, in the second embodiment, said at least one predetermined active pixel period (e.g., the uppermost active pixel period or the lowermost active pixel period) is adjacent to an area on the outside of the video data arranging area.

As described above, when the added position determination unit 234a of the TC adder 23a determines that the present period is the predetermined period in the video data arranging area based on the number of lines counted by the line counter 231 and the number of pixels counted by the pixel counter 232, and sends information of the determination to the switching unit 235, then the switching unit 235, which receives the information, switches “luma” to the packet of the time code (received from the packet generator 236), that is, frame data associated with the relevant frame. Accordingly, in the active pixel period, the switching unit 235 switches “luma” to the frame data, and outputs the frame data. Therefore, the TC adder 23a of the video transmitting apparatus 20a replaces at least one predetermined active pixel period of the video data with a signal which indicates the frame data, so that the frame data can be synthesized with the video data.

Also in the second embodiment, the frame data is contained in the video data arranging area. Therefore, the HDMI receiver 34 of the video receiving apparatus 30a, which receives the video signal, processes even the area, which includes the frame data, as video data, and outputs the originally-received video signal in which the frame data has been synthesized with the video data. Accordingly, even when the HDMI transmitter 24, which is used for transmitting a digital video signal from the video transmitting apparatus 20a to the video receiving apparatus 30a, is a device which cannot set auxiliary data, or can set auxiliary data but sets the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, even when the HDMI receiver 34, which is used for receiving a digital video signal transmitted from the video transmitting apparatus 20a to the video receiving apparatus 30a, is a device which cannot output auxiliary data, or can output auxiliary data but outputs the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, said at least one predetermined active pixel period (e.g., the uppermost active pixel period or the lowermost active pixel period) is adjacent to an area on the outside of the video data arranging area, that is, the pixels replaced with the frame data are positioned at an outer edge of the video data arranging area. Therefore, when the video data is displayed, only the uppermost or the lowermost line of the displayed image is affected by the replacement with the signal which indicates the frame data, and the audience is less likely to notice something strange.

Additionally, the period used for the replacement of the data included therein with the signal which indicates the time code may be a few pixels on the start or the end of the active pixel period, and such a period may be provided in a plurality of active pixel periods, so that the pixels replaced with the frame data are positioned at an outer edge of the video data arranging area. In such a case, when the relevant video data is displayed, only the left end, the right end, or the four corners of the displayed image are affected by the replacement with the signal which indicates the frame data, and the audience is less likely to notice something strange.

### Third Embodiment

Below, an embodiment in which the number of bits of pixel data of each pixel in video data is increased, and the time code is stored in the added bits will be explained as a third embodiment.

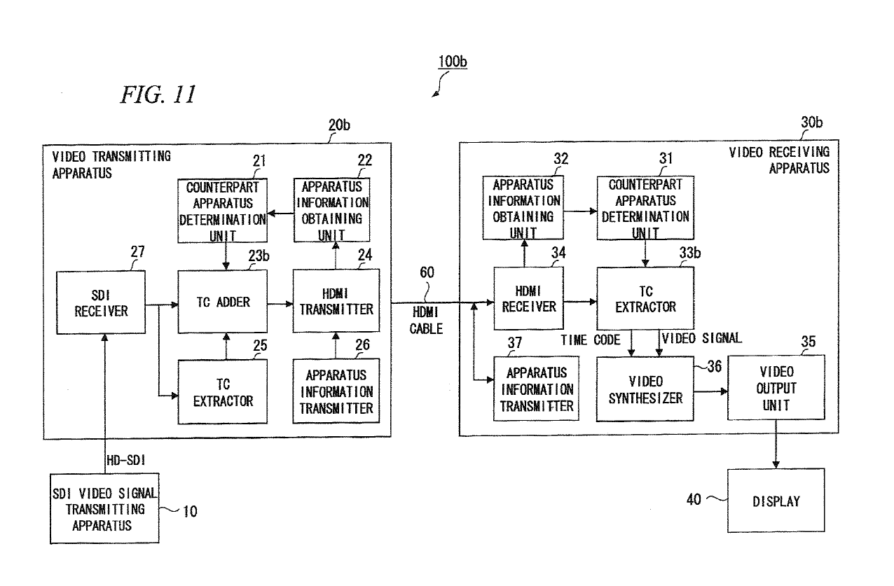

FIG. 11 is a general block diagram showing the structure of a video transmitting and receiving system as the third embodiment of the present invention. Referring to FIG. 11, in comparison with the video transmitting apparatus 20 and the video receiving apparatus 30 of the video transmitting and receiving system 100 of the first embodiment, the video transmitting and receiving system 100b has distinctive corresponding apparatuses, and thus has an SDI video signal transmitting apparatus 10, a video transmitting apparatus 20b, a video receiving apparatus 30b, a display 40, and an HDMI cable 60. The SDI video signal transmitting apparatus 10, the display 40, and the HDMI cable 60 are similar to those in the first embodiment, and explanations thereof are omitted. In comparison with the video transmitting apparatus 20 of the first embodiment, the only distinctive part of the video transmitting apparatus 20b is a TC adder 23b substituted for the TC adder 23. Therefore, explanations of the other parts (21, 22, and 24 to 27) are omitted. In comparison with the video receiving apparatus 30 of the first embodiment, the only distinctive part of the video receiving apparatus 30b is a TC extractor 33b substituted for the TC extractor 33. Therefore, explanations of the other parts (31, 32, and 34 to 37) are omitted.

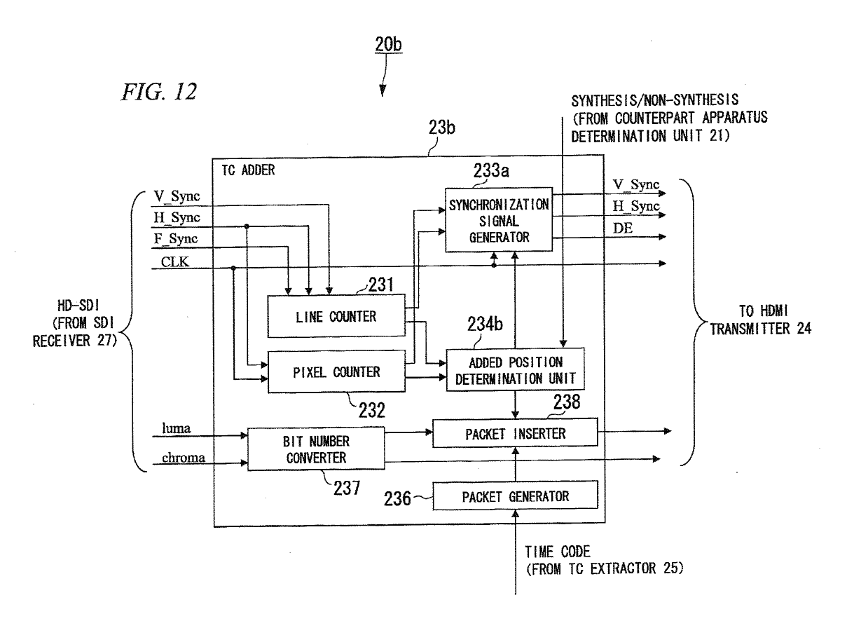

FIG. 12 is a general block diagram showing the structure of the TC adder in the third embodiment. In FIG. 12, parts identical to those in FIG. 4 are given identical reference numerals (231, 232, and 236), and explanations thereof are omitted. Referring to FIG. 12, the TC adder 23b has a line counter 231, a pixel counter 232, a synchronization signal generator 233a, an added position determination unit 234b, a packet generator 236, a bit number converter 237, and a packet inserter 238.

The synchronization signal generator 233a has a similar structure to that of the synchronization signal generator 233a in FIG. 9, and explanations thereof are omitted.

Similar to the added position determination unit 234 in FIG. 4, when the added position determination unit 234b receives a synthesis/non-synthesis designation from the counterpart apparatus determination unit 21 and the designation indicates “synthesis”, the added position determination unit 234b monitors the number of lines counted by the line counter 231 and the number of pixels counted by the pixel counter 232. When the monitored numbers respectively coincide with predetermined line and pixel numbers for storing the time code, the added position determination unit 234b informs the packet inserter 238 that the period for storing the time code has arrived. In comparison with the added position determination unit 234, in the added position determination unit 234b of the third embodiment, the period for storing the time code is an active pixel period in the received HD-SDI video signal.

The bit number converter 237 receives “luma” (brightness signal) and “chroma” (color difference signal), each having 8 bits, from the SDI receiver 27, and converts each signal into a 12-bit signal by adding lower 4 bits. According to a designation from the added position determination unit 234b, the packet inserter 238 stores packet data of the time code, which is received from the packet generator 236, into the lower 4 bits of “luma” (brightness signal), which is received from the bit number converter 237.

Accordingly, the TC adder 23b increases the number of bits of pixel data, which indicates the color of each pixel of the relevant video data, and stores the time code in the added bits.

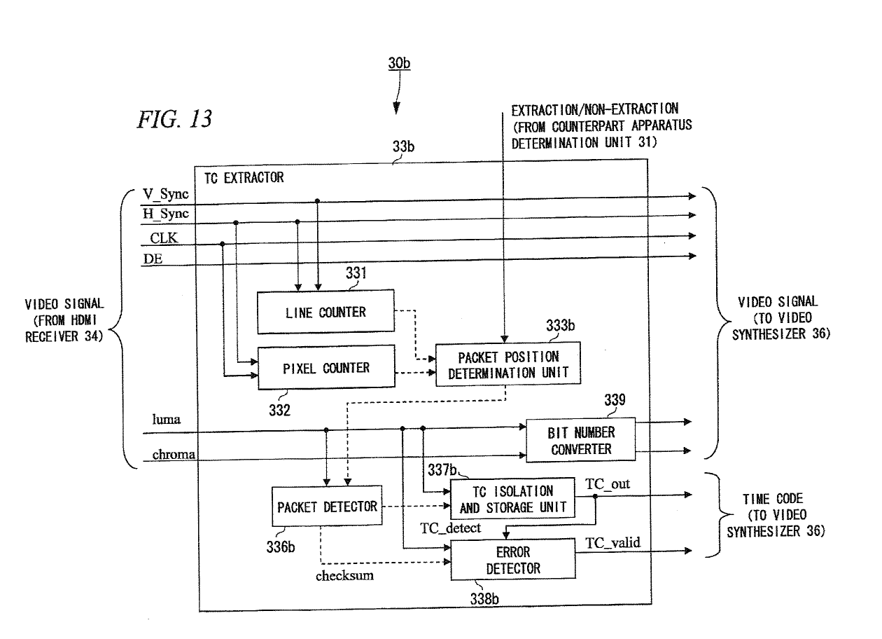

FIG. 13 is a general block diagram showing the structure of the TC extractor of the video receiving apparatus in the third embodiment. In FIG. 13, parts identical to those in FIG. 5 are given identical reference numerals (331 and 332), and explanations thereof are omitted. Referring to FIG. 13, in comparison with the TC extractor 33 in FIG. 5, which has the packet position determination unit 333, the packet detector 336, the TC isolation and storage unit 337, and the error detector 338, a TC extractor 33b has a packet position determination unit 333b, a packet detector 336b, a TC isolation and storage unit 337b, and an error detector 338b, has no DE remover 334 and TC remover 335, and also has a bit number converter 339.

Similar to the packet position determination unit 333, when the packet position determination unit 333b receives an extraction/non-extraction designation from the counterpart apparatus determination unit 31 and the designation indicates “extraction”, the packet position determination unit 333b monitors the number of lines counted by the line counter 331 and the number of pixels counted by the pixel counter 332. When the monitored numbers respectively coincide with predetermined line and pixel numbers for storing the time code, the packet position determination unit 333b informs the packet detector 336b that the period for storing the time code has arrived. However, in contrast with the packet position determination unit 333, the period for storing the time code is at least one predetermined active pixel period in which video data has been originally stored.

When the bit number converter 339 receives an extraction/non-extraction designation from the counterpart apparatus determination unit 31 and the designation indicates “extraction”, the bit number converter 339 removes the lower 4 bits of each of “luma” (brightness signal) and “chroma” (color difference signal), which are received from the HDMI receiver 34, so as to convert each signal to a 8-bit signal and output the converted signal. If the designation indicates “non-extraction”, the bit number converter 339 directly outputs the received “luma” and “chroma”.

The packet detector 336b receives “luma” from the HDMI receiver 34, and extracts a part of the signal, which corresponds to the header of the packet, from the lower 4 bits within the period which is communicated from the packet position determination unit 333b. The packet detector 336b then determines whether or not the extract part coincides with a header value which indicates that the relevant packet is a packet for storing the time code. When it is determined that they coincide with each other, the packet detector 336b outputs a signal, which indicates that the relevant packet has been detected, to the TC isolation and storage unit 337b at the time when the stored time code comes (see “TC_detect”), and also to the error detector 338b at the time when the stored error detection code comes (see “checksum”). When the TC isolation and storage unit 337b receives the signal, which indicates that the relevant packet has been detected, from the packet detector 336b, the TC isolation and storage unit 337b isolates and stores the lower 4 bits of “luma” as the time code, which is received from the HDMI receiver 34, and outputs the time code (see “TC_out”).

When the error detector 338b receives the signal, which indicates that the relevant packet has been detected, from the packet detector 336b, the error detector 338b isolates the lower 4 bits of “luma”, which is received from the HDMI receiver 34, as a code for error detection. The error detector 338b also computes a code for error detection by using the time code which has been isolated and stored by the TC separation and storage unit 337b, in a similar method performed by the packet generator 236, and compares the computed code with the above isolated code for error detection. The error detector 338b outputs a signal (“TC_valid”) indicating that the time code is effective when the compared codes coincide with each other, or that the time code is ineffective when both do not coincide with each other.

As described above, the bit number converter 237 of the TC adder 23b increases the number of bits of pixel data, which indicates the color of each pixel of the relevant video data, and the packet inserter 238 stores the time code in the added bits. Accordingly, the video transmitting apparatus 20b can insert a signal, which indicates frame data, in the video data arranging area of video data, specifically, at least one predetermined active pixel period, so as to synthesize the video data with the frame data.

Also in the third embodiment, the frame data is contained in the video data arranging area. Therefore, the HDMI receiver 34 of the video receiving apparatus 30b, which receives the relevant video signal, processes even the area, where the frame data is stored, as video data, and thus outputs the originally-received video signal in which the frame data has been synthesized with the video data. Accordingly, even when the HDMI transmitter 24, which is used for transmitting a digital video signal from the video transmitting apparatus 20b to the video receiving apparatus 30b, is a device which cannot set auxiliary data, or can set auxiliary data but sets the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, even when the HDMI receiver 34, which is used for receiving a digital video signal transmitted from the video transmitting apparatus 20b to the video receiving apparatus 30b, is a device which cannot output auxiliary data, or can output auxiliary data but outputs the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In the third embodiment, the number of bits of pixel data is increased by converting each of “luma” (brightness signal) and “chroma” (color difference signal) from a 8-bit signal to a 12-bit signal. However, the number of bits may be increased by converting, for example, YUV “4:2:2” to YUV “4:4:4” or RGB. Here, YUV “4:2:2” is a data format in which a 8-bit brightness signal is assigned to each pixel, but color difference signals for red and blue are each 8 bits for every two pair of pixels, and thus the number of bits for each pixel is 16. In addition, YUV “4:4:4” is a data format in which color difference signals for red and blue are each 8 bits for each pixel, a 8-bit brightness signal is assigned to each pixel, and thus the amount of data of each pixel is 24 bits. Additionally, RGB is a data format in which for each of R (red), G (green), and G(blue), a 8-bit signal is assigned to each pixel, and thus the amount of data of each pixel is 24 bits.

### Fourth Embodiment

Below, a fourth embodiment will be explained, in which an editing apparatus for video data outputs a video signal including a time code, similar to the video signal in the video transmitting apparatus 20 of the first embodiment.

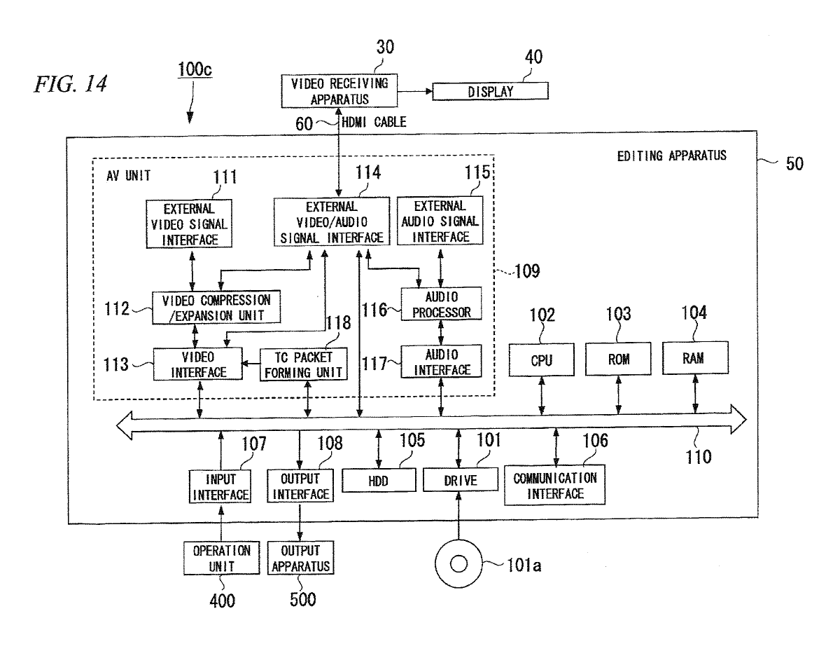

FIG. 14 is a general block diagram showing the structure of a video transmitting and receiving system as the fourth embodiment of the present invention. Referring to FIG. 14, the video transmitting and receiving system 100c has an editing apparatus 50, a video receiving apparatus 30, a display 40, and an HDMI cable 60. In FIG. 14, parts identical to those in FIG. 1 are given identical reference numerals (30, 40, and 60), and explanations thereof are omitted. The editing apparatus 50 and the video receiving apparatus 30 are connected to each other by the HDMI cable 60 used for transmitting a video signal based on the HDMI standard from the editing apparatus 50 to the video receiving apparatus 30. As shown in FIG. 14, the editing apparatus 50 includes a drive 101, a CPU (Central Processing Unit) 102, a ROM 103, a RAM 104, an HDD (Hard Disk Drive) 105, a communication interface 106, an input interface 107, an output interface 108, an AV unit 109, and a bus 110 for connecting the above devices.

A removable medium 101a, such as an optical disk, is mounted on the drive 101, and data is read from the removable medium 101a. In FIG. 14, the drive 101 is built in the editing apparatus 50, however, it may also be an external drive. Instead of the optical disk, the drive 101 may be, for example, a magnetic disk, a magneto-optical disk, a blu-ray disk, or a semiconductor memory device. In addition, material data may be read from resources on a network, which can be accessed via the communication interface 106.

The CPU 102 loads a control program, which is stored in the ROM 103, onto a volatile storage area such as the RAM 104, so as to control the entire operation of the editing apparatus 50.

An application program as the editing apparatus is stored in the HDD 105. The CPU 102 loads this application program on the RAM 104, so as to make a computer function as the editing apparatus. In addition, material data or edited data of each video clip, which is read from the removable medium 101a such as an optical disk, may be stored in the HDD 105. The access speed to the material data stored in the HDD 105 is higher in comparison with the optical disk mounted on the drive 101. Therefore, in an editing operation, delay in display can be reduced by using the material data stored in the HDD 105. The device for storing the edited data is not limited to the HDD 105, and any high-speed accessible storage device (such as, for example, a magnetic disk, a magneto-optical disk, a blu-ray disk, or a semiconductor memory device) may be used. Such a storage device on a network, which can be accessed via the communication interface 106, may also be used as the storage device to store edited data.

The communication interface 106 performs communication with a video camera, which may be connected via a USB (Universal Serial Bus), and receives data stored in a storage medium in the video camera. The communication interface 106 also can transmit the generated edited data to a resource on a network by means of LAN or the Internet.

The input interface 107 receives an instruction, which is input by a user by means of an operation unit 400 such as a keyboard or a mouse, and supplies an operation signal to the CPU 102 via the bus 110.

The output interface 108 supplies image data or audio data, which is received from the CPU 102, to an output apparatus 500 such as a display apparatus (e.g., an LCD (Liquid Crystal Display) or a CRT) or a speaker.

The AV unit 109 performs specific processes for video and audio signals, and has the following elements and functions.

An external video signal interface 111 is used for transmitting a video signal between an external device of the editing apparatus 50 and a video compression/expansion unit 112. For example, the external video signal interface 111 has input/output units for a DVI (Digital Visual Interface) signal, an analog composite signal, and an analog component signal.

A video compression/expansion unit 112 decodes compressed video data, which is supplied via the video interface 113, and outputs the obtained digital video signal to the external video signal interface 111 and the external video/audio signal interface 114. In addition, after subjecting an analog video signal, which is supplied from the external video signal interface 111 and the external video/audio signal interface 114, to digital conversion as necessity arises, the video compression/expansion unit 112 compresses the relevant data, for example, in MPEG2 format, and outputs the obtained data to the bus 110 via the video interface 113.

The video interface 113 performs data transmission between the video compression/expansion unit 112 or the external video/audio signal interface 114 and the bus 110 or a TC packet forming unit 118. In particular, for non-compressed data input from the bus 110 or the TC packet forming unit 118, the video interface 113 generates a video signal in synchronism with a clock signal, which is generated in the video interface 113 and in which one period corresponds to one pixel. The video interface 113 outputs the generated video signal to the external video/audio signal interface 114.

The TC packet forming unit 118 receives video data, which has a time code and input via the bus 110, and outputs the video data to the video interface 113. For the time code, the TC packet forming unit 118 computes a code for error detection from the time code, and outputs a packet, in which a predetermined header, the input time code, and the computed code for error detection are sequentially coupled, to the video interface 113.

The external video/audio signal interface 114 outputs an analog video signal and audio data, which are input from an external device, respectively to the video compression/expansion unit 112 and an audio processor 116. The external video/audio signal interface 114 also outputs a digital or analog video signal, which is supplied from the video compression/expansion unit 112 or the video interface 113, and a digital or analog audio signal, which is supplied from the audio processor 116, to an external device. The external video/audio signal interface 114 may be an interface based on HDMI or SDI (Serial Digital Interface). In the fourth embodiment, connection with the video receiving apparatus 30 is performed using an interface based on HDMI. In addition, the external video/audio signal interface 114 can be directly controlled by the CPU 102 via the bus 110.

The external audio signal interface 115 is used for transmitting an audio signal between an external device and the audio processor 116. The external audio signal interface 115 may be based on an interface standard for analog audio signals.

The audio processor 116 performs analog-to-digital conversion of an audio signal supplied via the external audio signal interface 115, and outputs the obtained data to the audio interface 117. The audio processor 116 also performs digital-to-analog conversion and audio control of audio data, which is supplied via the audio interface 117, and outputs the obtained signal to the external audio signal interface 115.

The audio interface 117 performs data supply to the audio processor 116, and data output from the audio processor 116 to the bus 110.

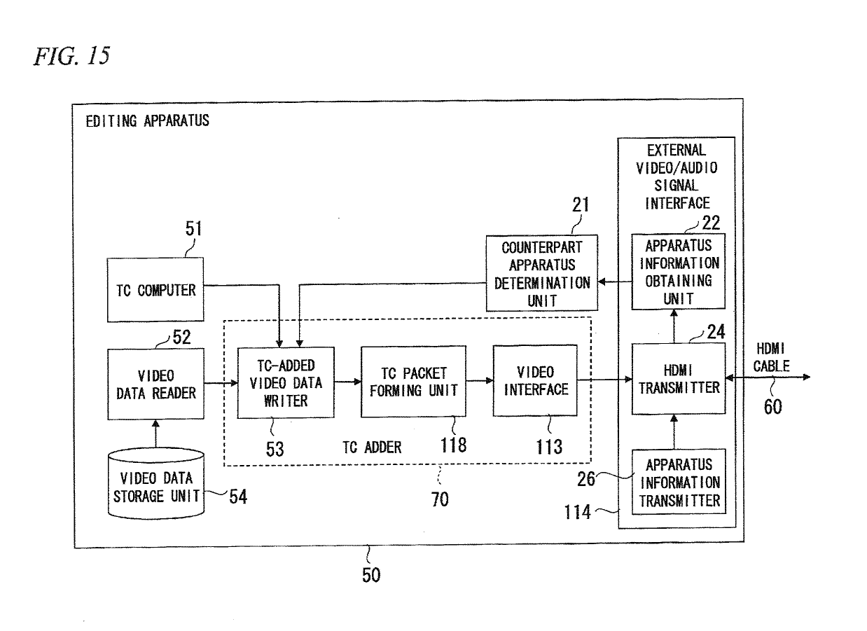

FIG. 15 is a general block diagram showing the function and structure of the editing apparatus in the fourth embodiment. Referring to FIG. 15, the editing apparatus 50 includes a TC computer 51, a video data reader 52, a TC-added video data writer 53, a video data storage unit 54, the TC packet forming unit 118, the video interface 113, a counterpart apparatus determination unit 21, and the external video/audio signal interface 114. The CPU 102 of the editing apparatus 50 functions as each of functional blocks which are the TC computer 51, the video data reader 52, the TC-added video data writer 53, and the counterpart apparatus determination unit 21, by means of an application program loaded on memory. The HDD 105 functions as the video data storage unit 54. The other parts, that is, the TC packet forming unit 118, the video interface 113, and the external video/audio signal interface 114 are formed using dedicated hardware circuits. In addition, the TC-added video data writer 53, the TC packet forming unit 118, and the video interface 113 function as a TC adder 70 (i.e., data synthesizer), and the video data storage unit 54 and the TC computer 51 function as sources for video data and its time code.

The external video/audio signal interface 114 has an apparatus information obtaining unit 22, an HDMI transmitter 24, and an apparatus information transmitter 26. In FIG. 15, parts identical to those in FIG. 4 are given identical reference numerals (21, 22, 24, and 26), and explanations thereof are omitted.

The video data storage unit 54 stores non-compressed video data. The video data reader 52 reads the non-compressed video data from the video data storage unit 54, and outputs the data to the TC-added video data writer 53. The TC computer 51 computes the time code of each frame of the video data, which is read by the video data reader 52, based on the frame rate of the video data, and outputs the time code to the TC-added video data writer 53. When the TC-added video data writer 53 is instructed by the counterpart apparatus determination unit 21 to perform “synthesis”, the TC-added video data writer 53 adds the time code to each frame of the video data, which is read by the video data reader 52, where the time code is computed by the TC computer 51 and corresponds to the relevant frame. The TC-added video data writer 53 outputs the obtained data to the TC packet forming unit 118. When the TC-added video data writer 53 receives a “non-synthesis” instruction, it directly outputs the video data, which is read by the video data reader 52, to the video interface 113.

As explained referring to FIG. 14, the TC packet forming unit 118 outputs video data, which is input via the bus 110 and has a time code for each frame, to the video interface 113. In this process, the TC packet forming unit 118 outputs the time code in a packet form to the video interface 113.

The video interface 113 receives the packet of the time code, which has been added for each frame of video data, and the video data from the TC packet forming unit 118, and outputs a video signal, which is used for transmitting the packet and the video data, to the HDMI transmitter 24 in the external video/audio signal interface 114, in synchronism with a clock signal (CLK), a vertical synchronization signal (V_sync), a horizontal synchronization signal (H_Sync), or the like.

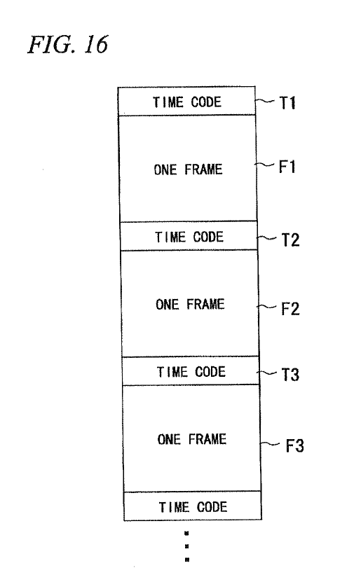

FIG. 16 is a diagram showing the structure of video data, which has the time code and is output from the TC-added video data writer in the fourth embodiment. Referring to FIG. 16, in the video data output from the TC-added video data writer 53, a time code and video data of one frame are alternately arranged. The time code indicated by reference symbol T1 is associated with the video data of one frame, which follows this time code and is indicated by the reference symbol F1. The time code indicated by the reference symbol T2 is associated with the video data of one frame, which follows this time code and is indicated by the reference symbol F2.

In the fourth embodiment, each time code corresponds to the subsequent video data of one frame, however, the opposite order is possible. That is, video data of one frame may correspond to the subsequent time code. In addition, if the scanning method of video data is interlace, each time code may be inserted between the top field and the bottom field of the frame with which the time code is associated.

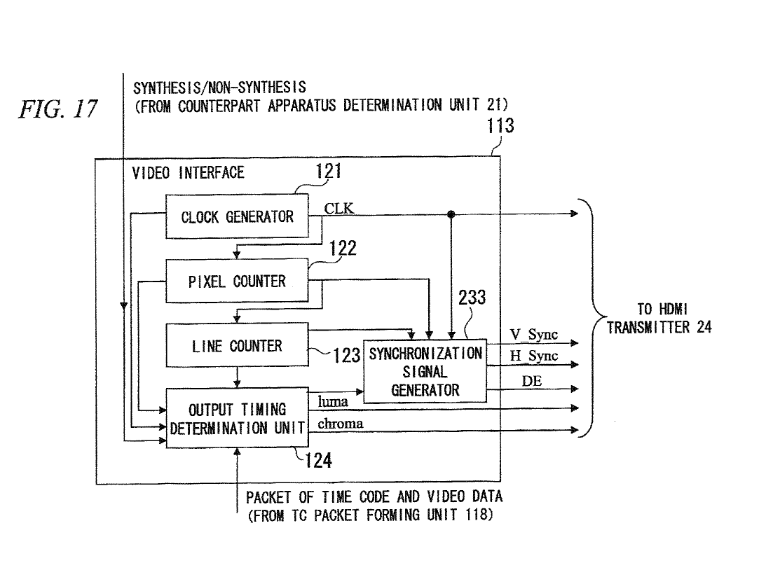

FIG. 17 is a general block diagram showing the structure of the video interface in the fourth embodiment. Referring to FIG. 17, the video interface 113 has a clock generator 121, a pixel counter 122, a line counter 123, an output timing determination unit 124, and a synchronization signal generator 233. The clock generator 121 generates a clock signal (CLK) in which each period indicates a pixel. The pixel counter 122 performs counting of the clock signal. When the pixel counter 122 has counted the number of pixels corresponding to the horizontal scanning line period, the pixel counter 122 resets the counted value. The line counter 123 counts the number of resetting events of the pixel counter 122, and resets the counted value when the number of resetting events reaches a value corresponding to the vertical synchronization period.

The output timing determination unit 124 receives the packet of the time code and the video data of each frame from the TC packet forming unit 118, and outputs the time code and the video data of each frame, as “luma” (brightness signal) and “chroma” (color difference signal), to the video data arranging area, at the timing based on the clock signal, the number of lines counted by the line counter 123, and the number of pixels counted by the pixel counter 122. When the output timing determination unit 124 does not output the above packet of the time code and video data of each frame, it outputs a predetermined value (e.g., 0), which indicates the horizontal or vertical blanking interval, as “luma” (brightness signal) and “chroma” (color difference signal).

For the packet of the time code and the video data of each frame, the output timing determination unit 124 outputs the packet as “luma” (brightness signal), so that the packet is arranged at the predetermined pixel and line numbers, which correspond to an active pixel period which is additionally provided by the synchronization signal generator 233 in a horizontal scanning line period of a vertical blanking interval. The number of counted lines and the number of counted pixels, where the time code is stored, are determined depending on the size of the frame of video data. In the example of FIG. 3, the period indicated by E1 is targeted, and thus the line number is “45”, and the pixel number is “139” to “858”. In addition, the output timing determination unit 124 outputs the video data of each frame in a manner such that each pixel has a brightness value as “luma” and a color difference as “chroma”.

The synchronization signal generator 233 monitors the number of lines counted by the line counter 123 and the number of pixels counted by the pixel counter 122 at the timing of the clock signal (CLK) from the clock generator 121, and performs switching of the High/Low state of each synchronization signal (i.e., horizontal synchronization signal (H_Sync), vertical synchronization signal (V_sync), and DE (Data Enable) signal (DE)) according to the resolution and the interlace/progressive form of the video image, so as to generate synchronization signals for the HDMI standard. In addition, while the synchronization signal generator 233 is informed by the output timing determination unit 124 that the present period is a period for storing a time code, the synchronization signal generator 233 switches the output state of the DE signal to “High” so that the HDMI transmitter 24 and the HDMI receiver 34 can recognize that the relevant period is the active pixel period. Accordingly, the synchronization signal generator 233, that is, the TC adder 70, additionally provides an active pixel period in a horizontal scanning line period of a vertical blanking interval, thereby enlarging the video data arranging area. The output timing determination unit 124, that is, the TC adder 70, then stores the packet of the time code (i.e., frame data) in the provided active pixel period.

As described above, the TC adder 70, which is formed by the TC-added video data writer 53, the TC packet forming unit 118, and the video interface 113, stores the time code as frame data into the video data arranging area, so as to synthesize it with the video data. Therefore, even when the HDMI transmitter 24, which is used for transmitting a digital video signal from the editing apparatus 50 to the video receiving apparatus 30, is a device which cannot set auxiliary data, or can set auxiliary data but sets the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, even when the HDMI receiver 34, which is used for receiving a digital video signal transmitted from the editing apparatus 50 to the video receiving apparatus 30, is a device which cannot output auxiliary data, or can output auxiliary data but outputs the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

Additionally, the area which is provided by the TC adder 70 and contains frame data is an active pixel period which is additionally provided in a horizontal scanning line period within a vertical blanking interval. Therefore, video data and frame data can be transmitted without damaging the video data.

As explained above, in the fourth embodiment, the time code is included in an added active pixel period, similar to the first embodiment. However, similar to the second embodiment, the time code may be transmitted by replacing video data, which is arranged in at least one predetermined active pixel period within a horizontal scanning line period, with the time code. In another example, similar to the third embodiment, the number of bits of pixel data, which indicates the color of each pixel of video data, may be increased, and the signal of the time code may be included in the added bits, to be transmitted.

Also in the above-explained fourth embodiment, the TC packet forming unit 118 is formed using a dedicated hardware resource. However, the CPU 102 may load an application program on memory, so as to form the TC packet forming unit 118.

Also in the fourth embodiment, the TC computer 51 computes the time code of each frame. However, the video data storage unit 54 may store the time code in association with each corresponding frame of video data, and the video data reader 52 may read the time code together with the video data.

### Fifth Embodiment

Below, a fifth embodiment will be explained, in which an editing apparatus for video data receives a video signal in which a time code is included in an active pixel period added on the transmission side, similar to the video receiving apparatus 30 of the first embodiment.

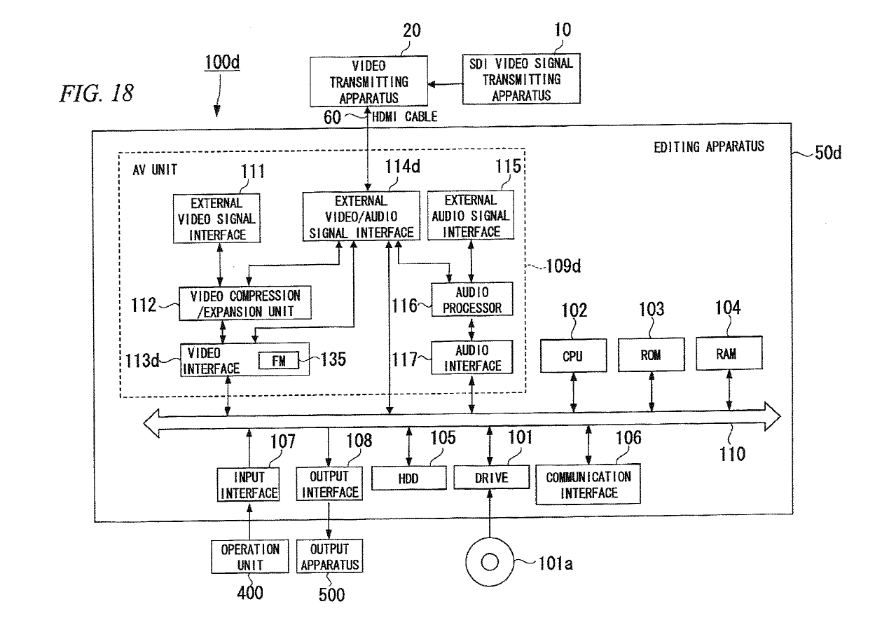

FIG. 18 is a general block diagram showing the structure of a video transmitting and receiving system as the fifth embodiment of the present invention. Referring to FIG. 18, the video transmitting and receiving system 100d has an SDI video signal transmitting apparatus 10, a video transmitting apparatus 20, an editing apparatus 50d, an HDMI cable 60, an operation unit 400, and an output apparatus 500. The video transmitting apparatus 20 and the editing apparatus 50d are connected to each other by the HDMI cable 60 used for transmitting a video signal based on the HDMI standard from the video transmitting apparatus 20 to the editing apparatus 50d. As shown in FIG. 18, the editing apparatus 50d includes a drive 101, a CPU 102, a ROM 103, a RAM 104, an HDD 105, a communication interface 106, an input interface 107, an output interface 108, an AV unit 109d, and a bus 110 for connecting the above devices.

Also referring to FIG. 18, the AV unit 109d includes an external video signal interface 111, a video compression/expansion unit 112, a video interface 113d, an external video/audio signal interface 114d, an external audio signal interface 115, an audio processor 116, and an audio interface 117. In FIG. 18, parts identical to those in FIG. 1 or 14 are given identical reference numerals (10, 20, 101, 101a, 102 to 108, 110 to 112, and 115 to 117), and explanations thereof are omitted.

The external video/audio signal interface 114d receives a video signal based on the HDMI standard from the video transmitting apparatus 20, and outputs the video signal and an audio signal superimposed on the video signal respectively to the video interface 113d and the audio processor 116.

The video interface 113d performs data transmission between the side of the video compression/expansion unit 112 and the external video/audio signal interface 114d, and the side of the bus 110. That is, the video interface 113d receives a video signal, which the external video/audio signal interface 114d have received, via the video compression/expansion unit 112, and outputs video data of each frame, which also includes the time code extracted from the video signal, to a frame memory 135. The frame memory 135 is included in the video interface 113d, and reading/writing operation thereof can be performed by the CPU 102 via the bus 110.

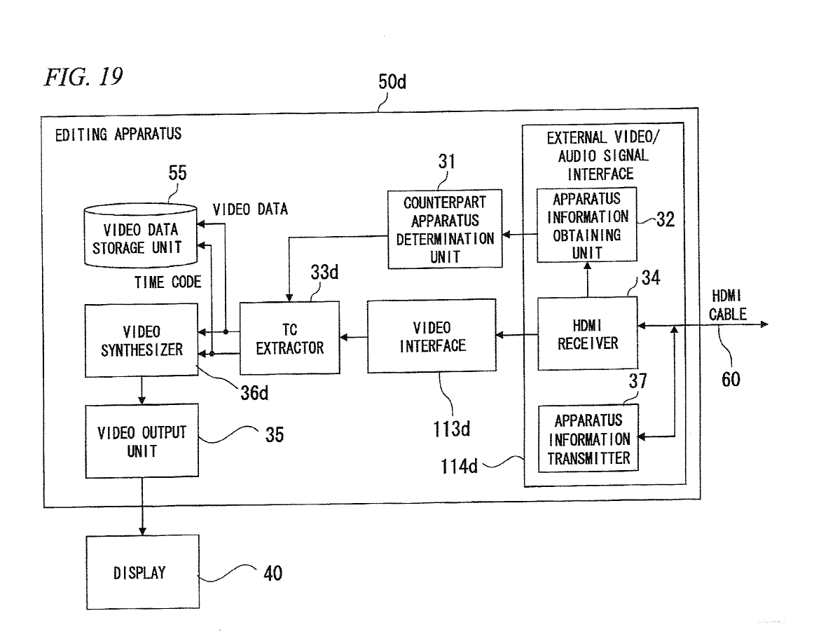

FIG. 19 is a general block diagram showing the function and structure of the editing apparatus in the fifth embodiment. Referring to FIG. 19, the editing apparatus 50d includes a video data storage unit 55, a video synthesizer 36d, a video output unit 35, a TC extractor 33d, the video interface 113d, a counterpart apparatus determination unit 31, and the external video/audio signal interface 114d. The CPU 102 of the editing apparatus 50d functions as each of functional blocks which are the video synthesizer 36d, the TC extractor 33d, and the counterpart apparatus determination unit 31, by means of an application program loaded on memory. The HDD 105 functions as the video data storage unit 55. An output interface 108 functions as the video output unit 35, and a display 40 is a part of the output apparatus 500. The other parts, that is, the video interface 113d, the video compression/expansion unit 112, and the external video/audio signal interface 114d are formed using dedicated hardware circuits.

The external video/audio signal interface 114d has an apparatus information obtaining unit 32, an HDMI receiver 34, and an apparatus information transmitter 37. In FIG. 19, parts identical to those in FIG. 1 or 18 are given identical reference numerals (31, 32, 34, 35, 37, 40, 114d, and 113d), and explanations thereof are omitted.

Among the data for the active pixel period, which is stored in the frame memory 135 included in the video interface 113d, the TC extractor 33d reads data corresponding to video data of one frame, which is stored at a video storage address predetermined for storing the video data of one frame, and also reads data of a packet from a packet storage address predetermined for storing the time code. The TC extractor 33d outputs the data, which is read from the video storage address, as video data to the video data storage unit 55 and the video synthesizer 36d.

For the data read from the packet storage address, the TC extractor 33d determines whether or not the upper 4 bytes thereof have a header value of the relevant packet. If they have the header value, the TC extractor 33d regards the 4-byte data, which follows the header, as a time code, and computes a code for error detection. The TC extractor 33d regards 2 bytes, which follow the time code, as the code for error detection, and compares it with the above computed code for error detection. When both coincide with each other, the TC extractor 33d outputs the 4 bytes, which have been regarded as the time code, to the video data storage unit 55 and the video synthesizer 36d. In this process, the TC extractor 33d outputs the above 4 bytes in a manner such that correspondence of the time code to the relevant frame can be determined, for example, outputs the 4 bytes immediately after the video data of the frame with which the time code has been associated. As described above, among the data for the active pixel period, which is stored in the frame memory 135, the TC extractor 33d reads data of a packet from the packet storage address, so as to extract the frame data included in the active pixel period, and outputs the time code and the video data to each of the video data storage unit 55 and the video synthesizer 36d, thereby generating video data from which the relevant active pixel period (from which the time code has been extracted) is removed.

The video synthesizer 36d generates image data of characters which indicate the time code received from the TC extractor 33d, and then generates video data of a video image in which the characters of the generated image data are inserted in a video image which shows the video data received from the TC extractor 33d. The video synthesizer 36d outputs the generated video data to the video output unit 35.

The video data storage unit 55 stores the video data of each one frame and its time code, which are output from the TC extractor 33d, in a manner such that correspondence is established therebetween. The video data and the time code, which are stored in the video data storage unit 55, can be used as video data to be edited in the editing apparatus 50d.

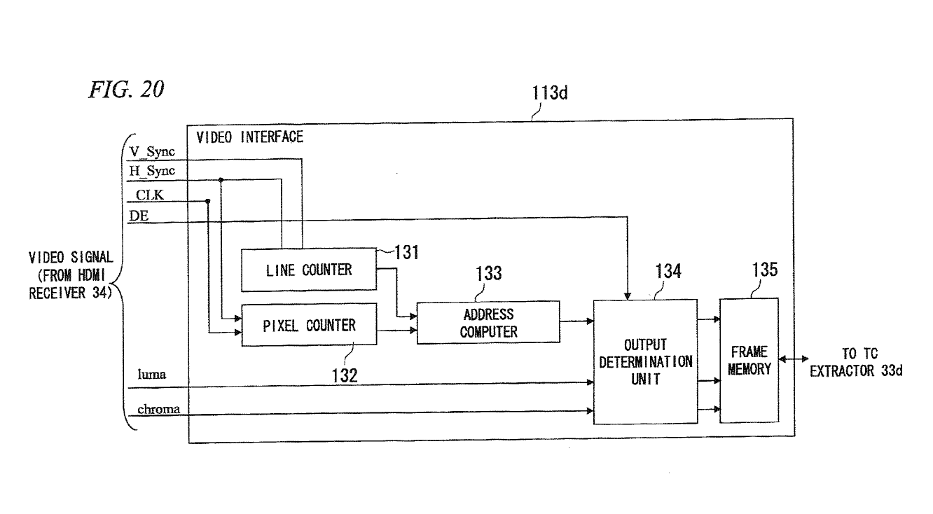

FIG. 20 is a general block diagram showing the structure of the video interface in the fifth embodiment. Referring to FIG. 20, the video interface 113d has a line counter 131, a pixel counter 132, an address computer 133, an output determination unit 134, and the frame memory 135. From the video compression/expansion unit 112, the video interface 113d receives a vertical synchronization signal (V_sync), a horizontal synchronization signal (H_sync), a clock signal (CLK), a DE signal (DE), “luma” (brightness signal), and “chroma” (color difference signal).

The line counter 131 is reset by the vertical synchronization signal, and performs counting of the horizontal synchronization signal. The pixel counter 132 is reset by the horizontal synchronization signal, and performs counting of the clock signal. Based on the number of lines counted by the line counter 131 and the number of pixels counted by the pixel counter 132, the address computer 133 computes an address of the frame memory 135, at which the values of brightness and color difference of a target pixel should be stored. In the address computation, first, the number of horizontal scanning lines, which corresponds to the vertical blanking interval, is subtracted from the number of lines counted by the line counter 131, and the result of the subtraction is multiplied by the number of pixels in one active pixel period and the amount of data for one pixel. Next, the number of pixels, which corresponds to the horizontal blanking interval, is subtracted from the number of pixels counted by the pixel counter 132, and the result of the subtraction is added to the result of the above multiplication. The head address for storing the video data of the relevant frame is added to the result of the above addition.

The video storage address and the packet storage address, which have been explained with respect to the TC extractor 33d, are computed based on the above head address. For example, when the active pixel period, which includes the relevant packet, is positioned at the head of the video data arranging area, the packet storage address is the same as the head address, and the video storage address is a value obtained by adding the amount of pixel data of one active pixel period to the head address.

The output determination unit 134 receives the DE signal, the address computed by the address computer 133, “luma”, and “chroma”. If the received DE signal is a “High” signal, which indicates that “luma”, and “chroma”, which are also received synchronously, are video data, then the output determination unit 134 writes the values of the received “luma”, and “chroma” at the received address in the frame memory 135. On the contrary, if the received DE signal is a “Low” signal, which indicates that “luma”, and “chroma”, which are also received synchronously, are not video data, then the output determination unit 134 does not perform writing to the frame memory 135. Accordingly, the output determination unit 134 writes the video data and the packet of the time code, which have been included in the video signal output from the HDMI receiver 34, into the frame memory 135.

As described above, the TC extractor 33d extracts the time code as frame data from the video data arranging area. Therefore, even when the HDMI transmitter 24, which is used for transmitting a digital video signal from the video transmitting apparatus 20 to the editing apparatus 50, is a device which cannot set auxiliary data, or can set auxiliary data but sets the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

In addition, even when the HDMI receiver 34, which is used for receiving a digital video signal transmitted from the video transmitting apparatus 20 to the editing apparatus 50, is a device which cannot output auxiliary data, or can output auxiliary data but outputs the auxiliary data and the video signal asynchronously, video data and frame data can be transmitted so that the side which uses the HDMI receiver 34 (i.e., a unit on the outside of the HDMI receiver 34) can easily determine with which frame of the video data the frame data is associated.

As explained above, in the fifth embodiment, the signal of the time code is included in an added active pixel period, similar to the first embodiment. However, similar to the second embodiment, the signal of the time code may be transmitted by replacing video data, which is included in at least one predetermined active pixel period, with the signal, and the time code included in said at least one predetermined active pixel period may be extracted. In another example, similar to the third embodiment, the number of bits of pixel data, which indicates the color of each pixel of video data, may be increased, and the signal of the time code may be included in predetermined bits (i.e., the added bits) and transmitted. The time code included in the predetermined bits may be extracted, and video data from which the predetermined bits are removed may be generated.

In the above explained first to fourth embodiments, the HDMI transmitter 24 cannot provide auxiliary data. However, it may be a device which receives auxiliary data and video data asynchronously, that is, cannot embed the auxiliary data in synchronism with the video data. When the auxiliary data cannot be embedded in synchronism with the video data, an external unit of the HDMI transmitter 24, which inputs the auxiliary data and the video data to the HDMI transmitter 24, cannot accurately determine in which frame of the video data the input auxiliary data is embedded. In addition, when the HDMI transmitter 24 is formed by an LSI, the LSI may have the apparatus information obtaining unit 22 and the apparatus information transmitter 26.

Additionally, in the first to third, and fifth embodiments, the HDMI receiver 34 may be a device which cannot output auxiliary data, or outputs auxiliary data and video data asynchronously, that is, cannot output auxiliary data and video data synchronously. When the auxiliary data and the video data cannot be output synchronously, an external unit of the HDMI receiver 34 cannot accurately determine in which frame of the video data, the auxiliary data output from the HDMI receiver 34, has been embedded. In addition, when the HDMI receiver 34 is formed by an LSI, the LSI may have the apparatus information obtaining unit 32 and the apparatus information transmitter 37.

In the first to fifth embodiments, the time code is used as frame data. However, this is not a limiting condition, and the frame data may be different auxiliary data (e.g., a caption or a combination of a time code and a caption or the like), that is, different data associated with each frame.

Although preferred embodiments of the present invention have been described above in detail, the present invention is not limited to such particular embodiments, and various modifications or variations may be made within the scope of the present invention recited in the claims.

### INDUSTRIAL APPLICABILITY

The present invention is preferably applied to an editing apparatus for editing video images for high definition televisions, or a converter for converting an HD-SDI video signal to an HDMI video signal. However, application of the present invention is not limited to the above.

### EXPLANATION OF REFERENCE

20, 20a, 20b Video transmitting apparatus

21, 31 Counterpart apparatus determination unit

22, 32 Apparatus information obtaining unit

23, 23a, 23b, 70 TC adder

24 HDMI transmitter

25, 33, 33a, 33b, 33d TC extractor

26, 37 Apparatus information transmitter

27 SDI receiver

30, 30a, 30b Video receiving apparatus

34 HDMI receiver

36, 36d Video synthesizer

50, 50d Editing apparatus

51 TC computer

60 HDMI Cable

100, 100a, 100b, 100c, 100d Video transmitting and receiving system

102 CPU

113, 113d Video interface

114, 114d External video/audio signal interface

1. A transmitting apparatus for transmitting transmission data to a receiving apparatus, the transmitting apparatus comprising:
means for obtaining apparatus information of the receiving apparatus; a source of video data and its auxiliary data;
means for determining whether or not to synthesize the video data and the auxiliary data with each other, based on the obtained apparatus information;
means for synthesizing, according to the above determination, the video data and frame data which is the auxiliary data associated with a frame of the video data, to generate the transmission data, wherein the frame data is included in a video data arranging area of the video data; and
means for transmitting the transmission data to the receiving apparatus.

2. The transmitting apparatus according to claim 1, wherein the synthesizing means provides an area including the frame data in the video data arranging area.

3. The transmitting apparatus according to claim 2, wherein:
the video data arranging area is active pixel periods in a plurality of horizontal scanning line periods; and
the area including the frame data is an active pixel period which is additionally provided in a horizontal scanning line period within a vertical blanking interval.

4. The transmitting apparatus according to claim 1, wherein:
the video data arranging area is active pixel periods in a plurality of horizontal scanning line periods; and
the synthesizing means replaces part of the video data, said part being arranged in at least one predetermined active pixel period of a horizontal scanning line period, with the frame data.

5. The transmitting apparatus according to claim 4, wherein pixels replaced with the frame data are positioned at an outer edge of the video data arranging area.

6. The transmitting apparatus according to claim 1, wherein the synthesizing means increases the number of bits of pixel data which indicates color of each pixel of the video data, and stores the frame data in the added bits.

7. A transmitting apparatus for transmitting transmission data to a receiving apparatus, the transmitting apparatus comprising:
a source of video data and its auxiliary data;
a data synthesizer for synthesizing the video data and frame data which is the auxiliary data associated with a frame of the video data, to generate the transmission data, wherein the frame data is included in a video data arranging area of the video data;
a CPU;
a transmitter
wherein:
the CPU is configured to:
obtain apparatus information of the receiving apparatus;
determine whether or not to synthesize the video data and the auxiliary data with each other, based on the obtained apparatus information; and
make the transmitter transmit the transmission data generated by the data synthesizer to the receiving apparatus when it is determined to synthesize the video data and the auxiliary data.

8. The transmitting apparatus according to claim 7, wherein the data synthesizer includes:
a clock generator for generating a clock signal in which one period corresponds to one pixel;
a pixel counter for performing counting of the clock signal so as to generate a horizontal synchronization signal;
a line counter for performing counting of the horizontal synchronization signal so as to generate a vertical synchronization signal;
a data arranging unit for performing counting of the clock signal and the horizontal synchronization signal so as to arrange the transmission data in the video data arranging area; and
a data writer configured by the CPU which inputs the video data and the auxiliary data into the data arranging unit.

9. The transmitting apparatus according to claim 7, wherein:
the auxiliary data is a time code of the video data; and
the source of the auxiliary data is configured by the CPU which computes the time code based on the frame rate of the video data.

10. The transmitting apparatus according to claim 7, wherein when the data synthesizer generates the transmission data, the data synthesizer provides an area including the frame data in the video data arranging area.

11. The transmitting apparatus according to claim 10, wherein:
the video data arranging area is active pixel periods in a plurality of horizontal scanning line periods; and
the area including the frame data is an active pixel period which is additionally provided in a horizontal scanning line period within a vertical blanking interval.

12. The transmitting apparatus according to claim 7, wherein:
the video data arranging area is active pixel periods in a plurality of horizontal scanning line periods; and
when the data synthesizer generates the transmission data, the data synthesizer replaces part of the video data, said part being arranged in at least one predetermined active pixel period of a horizontal scanning line period, with the frame data.

13. The transmitting apparatus according to claim 12, wherein pixels replaced with the frame data are positioned at an outer edge of the video data arranging area.

14. The transmitting apparatus according to claim 7, wherein when the data synthesizer generates the transmission data, the data synthesizer increases the number of bits of pixel data which indicates color of each pixel of the video data, and stores the frame data in the added bits.

15. The transmitting apparatus according to claim 7, wherein the transmission data is based on the HDMI standard.

16. A receiving apparatus comprising:
means for receiving data which includes video data and frame data which is arranged in a video data arranging area of each frame of the video data, and is associated with the frame;
means for extracting the frame data from the video data arranging area;
means for synthesizing the video data with the frame data for each frame; and
means for outputting the synthesized video data and frame data.

17. The receiving apparatus according to claim 16, wherein:
the video data arranging area is active pixel periods in a plurality of horizontal scanning line periods; and
the extracting means extracts the frame data, which is included in the active pixel periods, and generates video data, from which each active pixel period from which the frame data has been extracted is removed.

18. The receiving apparatus according to claim 16, wherein:
the video data arranging area is active pixel periods in a plurality of horizontal scanning line periods; and
the extracting means extracts the frame data included in at least one predetermined active pixel period of the video data.

19. The receiving apparatus according to claim 18, wherein pixels from which the frame data is extracted are positioned at an outer edge of the video data arranging area.

20. The receiving apparatus according to claim 16, wherein the extracting means extracts the frame data included in predetermined bits of pixel data which indicates color of each pixel of the video data, and generates video data from which the predetermined bits are removed.

21. A receiving apparatus comprising:
a receiver for receiving data which includes video data and frame data which is arranged in a video data arranging area of each frame of the video data, and is associated with the frame;
a CPU; and
an output unit for outputting the synthesized video data and frame data, wherein the CPU is configured to:
extract the frame data from the video data arranging area; and
synthesize the video data and the frame data for each frame.

22. The receiving apparatus according to claim 21, wherein:
the video data arranging area is active pixel periods in a plurality of horizontal scanning line periods; and
when extracting the frame data, the CPU extracts the frame data included in the active pixel periods, and generates video data, from which each active pixel period from which the frame data has been extracted is removed.

23. The receiving apparatus according to claim 21, wherein: the video data arranging area is active pixel periods in a plurality of horizontal scanning line periods; and
when extracting the frame data, the CPU extracts the frame data included in at least one predetermined active pixel period of the video data.

24. The receiving apparatus according to claim 23, wherein pixels from which the frame data is extracted are positioned at an outer edge of the video data arranging area.

25. The receiving apparatus according to claim 21, wherein when extracting the frame data, the CPU extracts the frame data included in predetermined bits of pixel data which indicates color of each pixel of the video data, and generates video data from which the predetermined bits are removed.

26. A system having a transmitting apparatus and a receiving apparatus which is connected to the transmitting apparatus, wherein:
the transmitting apparatus comprises:
means for obtaining apparatus information of the receiving apparatus; a source of video data and its auxiliary data;
means for determining whether or not to synthesize the video data and the auxiliary data with each other, based on the obtained apparatus information;
means for synthesizing, according to the above determination, the video data and frame data which is the auxiliary data associated with a frame of the video data, to generate transmission data, wherein the frame data is included in a video data arranging area of the video data; and
means for transmitting the transmission data to the receiving apparatus; and the receiving apparatus comprises:
means for receiving the transmission data;
means for extracting the frame data from the video data arranging area;
means for synthesizing the video data with the frame data for each frame; and
means for outputting the synthesized video data and frame data.

27. A method for transmitting transmission data to a receiving apparatus, the method comprising the steps of:
obtaining apparatus information of the receiving apparatus;
determining whether or not to synthesize supplied video data and auxiliary data with each other, based on the obtained apparatus information;
synthesizing, according to the above determination, the video data and frame data which is the auxiliary data associated with a frame of the video data, to generate the transmission data, wherein the frame data is included in a video data arranging area of the video data; and
transmitting the transmission data to the receiving apparatus.

28. A method comprising the steps of:
receiving data which includes video data and frame data which is arranged in a video data arranging area of each frame of the video data, and is associated with the frame;
extracting the frame data from the video data arranging area;
synthesizing the video data with the frame data for each frame; and
outputting the synthesized video data and frame data.
